(19) United States
(12) Patent Application Publication
(10) Pub. No.: US 2026/0308311 A1
(43) Pub. Date: Oct. 8, 2026

(54) PROCESS FOR PREPARING CRYSTALLIZED POLYLACTIDE

(71) Applicant: TOTALENERGIES CORBION BV, Gorinchem (NL)

(72) Inventors: Denis LOOZEN, WATERLOO (BE); Wachiraporn DAENGPRASERT, Muang Rayong (TH)

(73) Assignee: TOTALENERGIES CORBION BV, Gorinchem (NL)

(21) Appl. No.: 18/998,350

(22) PCT Filed: Oct. 2, 2023
(86) PCT No.: PCT/EP2023/077248

§ 371 Date: Jan. 24, 2025

(30) Foreign Application Priority Data
Oct. 3, 2022 (EP) 22199355.3

(51) Int. Cl. C08G 63/08; B29C 71/02; C08K 5/20

(52) U.S. Cl. CPC C08G 63/08; C08J 7/08; C08K 5/20

(57) ABSTRACT

The present invention relates to a process for improving the crystallization of polylactide, and in particular for increasing crystallization speed of a PLA polymer. The present invention relates to a process for the preparation of crystallized PLA pellets, which in particular comprises the steps of: a) providing a PLA polymer melt, wherein the PLA polymer has a content of D-lactide isomer of between 1.0 and 10.0 wt % of said PLA polymer; b) pelletizing the PLA polymer melt into PLA pellets, and c) crystallizing said PLA pellets, thereby obtaining a crystallized PLA pellets, wherein said process is characterised in that amide, preferably a fatty acid amide, is added to said PLA polymer melt prior to pelletization, to form a PLA polymer melt comprising amide in a total amount of between 10 and 2000 ppm of the PLA polymer melt. The present invention also relates to a crystallised PLA, in particular crystallized PLA pellets, obtainable or obtained by carrying out a process of the invention.

### FIELD OF THE INVENTION

The present invention relates to the field of polylactide processing. The present invention in particular relates to a process for the preparation of a crystallized polylactide. The present invention particularly relates to a process for the preparation of crystallised PLA pellets and the crystallised PLA pellets thereby obtained. The present invention in particular provides a process for enhancing the crystallization rate of polylactide, in particular of PLA pellets.

### BACKGROUND OF THE INVENTION

The demand for biodegradable polymers with excellent material properties is rapidly growing. Biodegradable polymers can be used in various applications, from biomedicine, additive technologies, film, fibers, packaging, automotive to agriculture, etc. Polylactide, which is also referred to as polylactic acid and abbreviated as PLA, has been receiving increasing attention in recent years for use in these applications, because of its excellent performances in renewability, mechanical properties, biocompatibility and biodegradability.

PLA polymers also find their application in both rigid and flexible disposable/compostable applications such as cups, plates, shopping bags, cutlery, etc., which often come in direct contact with food. Such polymers may comprise inorganic fillers, and other additives, in order to enhance for instance material properties such as rigidity, thermal properties, and to extend the volume of the resin. However, materials or articles that come into direct contact with food and drinks, need to fulfil specific criteria with respect to safety and (chemical) stability. Such materials or articles should not change the nature, substance or quality of the food and must not transfer their components (i.e., migrate) into the food in unacceptable quantities. Thus, providing biodegradable polymers which at the same time fulfil criteria allowing to be used as “food contact material”, is a challenging task.

PLA is an aliphatic polyester, which can be manufactured from renewable resources. Such manufacture may involve the fermentation of starch, sugar or other renewable organic substrates into lactic acid. Polylactide can be produced by direct polycondensation of lactic acid, i.e. lactate monomers. However, this has the drawback that a high molecular weight is not easily reached. Therefore, PLA is usually prepared by ring-opening polymerization (ROP) of lactide, the cyclic dimer of lactic acid, which in turn is usually manufactured by polycondensation of lactic acid into PLA oligomers, followed by de-polymerization of these oligomers by a so-called ‘backbiting’ mechanism in the presence of a suitable catalyst. After purification, the produced lactide can be converted into PLA of controlled molecular weight by means of a ring-opening polymerization reaction (ROP) in the presence of a polymerization catalyst and initiator. Ring-opening polymerization allows to control the polymerization process and thereby the structure of the produced PLA. This method can be used to manufacture PLA of high molecular weight. The molecular weights of the polymer fabricated by the ring opening polymerization can be controlled by residence time, catalyst and initiator concentration, and temperature. The sequence and ratio of L- and D-lactic acid units in the final polymer can also be controlled. After polymerization polylactide pellets are typically obtained through the steps of melt extrusion and pelletization.

Solid-state PLA has two forms: amorphous and crystalline. The amorphous form is more transparent and becomes soft and sticky above its glass transition temperature whereas the crystalline form is more opaque, white and remains hard and non-sticky up until the melting point is reached. PLA with a certain crystallisation degree is often required for various applications.

Directly after pelletizing, the PLA pellets formed have an amorphous structure and a very tacky surface, and their soft and stickiness behaviour makes it difficult to further process, dry, and/or store these pellets. The amorphous structure can be converted into an at least partly crystalline state having greater alignment among its molecular chains in a thermal post-treatment step that is also referred to as crystallization. Crystallization is a particularly important process because it controls the polymer's structural formation and thereby strongly influences the final products' properties. Crystallization is typically carried out in dedicated equipment.

However, crystallizing PLA is made difficult because PLA pellets will be sticky at the start of the crystallization process. Handling of the hot amorphous sticky pellets during crystallization is troublesome and can lead to blockage of equipment and processing issues.

Also, PLA is characterized by a slow crystallization rate. This is especially so during the non-isothermal conditions encountered in normal extrusion and injection moulding processes, where it is hard to achieve high PLA crystallinity in a short time. Therefore, the question of how to enhance crystallization behaviour and increase crystallinity has been widely addressed in the PLA processing field.

It is therefore an object of the present invention to provide an improved process for preparing PLA of a desirable degree of crystallinity, which overcomes at least some of the above-mentioned drawbacks.

It is in particular an object of the present invention to provide an improved process for preparing crystallised PLA pellets having desirable composition allowing them to be effectively used in various kinds of downstream applications.

It is a further object of the present invention to provide crystallized PLA pellets having optimal properties, such that they can be further processed and used for a wide range of applications without constraints in terms of stability, chemical compatibility, food safety, and/or migration problems.

It is a further object of the present invention to provide a simplified and more cost-effective process for obtaining crystallized PLA pellets.

### SUMMARY OF THE INVENTION

It has now surprisingly been found that some or all of the above demands and objectives can be attained either individually or in any combination by a process for the preparation of crystallized polylactide (PLA) as defined herein. The present invention presents an improved process for the preparation of crystallised PLA, which increases crystallization speed of the PLA polymer, and provides easier and more fluent processing of PLA polymer into crystallised PLA, while eliminating, or at least greatly reducing, blocking issues in processing equipment.

In one aspect, the present invention relates to a process for the preparation of crystallized polylactide (PLA), said process comprising the steps of:
a) providing a PLA polymer melt, wherein the PLA polymer has a content of D-lactide isomer of between 1.0 and 10.0 wt % of said PLA polymer;
b) processing said PLA polymer melt into PLA pellets, and
c) crystallizing said PLA pellets thereby obtaining a crystallized PLA, wherein said process is characterised in that an amide is added to said PLA polymer melt in an amount of between 10 and 2000 ppm of the PLA polymer melt.

In particular, said amide is added to said PLA polymer melt prior to processing said PLA polymer melt into PLA pellets. Hence, the present invention also relates to a process for the preparation of crystallized polylactide (PLA) pellets.

In accordance with the present invention, a process for the preparation of crystallized polylactide (PLA) pellets is provided, wherein the process comprises the steps of:
a) providing a PLA polymer melt, wherein the PLA polymer has a content of D-lactide isomer of between 1.0 and 10.0 wt % of said PLA polymer,
b) pelletizing the PLA polymer melt into PLA pellets, and
c) crystallizing the PLA pellets, thereby obtaining crystallized PLA pellets, wherein said process is characterised in that amide is added to said PLA polymer melt before step b) to form a PLA polymer melt comprising amide in a total amount of between 10 and 2000 ppm of the PLA polymer melt.

In preferred embodiments of a process of the invention, the PLA pellets are crystallised by means of latent heat crystallisation. It is thus preferred that during pelletizing the average PLA pellet temperature remains above the glass transition temperature (Tg) of the PLA polymer.

In preferred embodiments of a process of the invention, said amide is added in an amount of between 20 and 1500 ppm, preferably between 30 and 1000 ppm, and more preferably between 50 and 900 ppm, of the PLA polymer melt. In certain preferred embodiments of the present process, amide is added to form a PLA polymer melt comprising amide in a total amount of between 20 and 1500 ppm, or between 30 and 1000 ppm, or between 50 and 900 ppm, or between 100 and 900 ppm, of the PLA polymer melt.

The present invention deals in particular with PLA polymers that have a D-lactide isomer content of between 1.0 and 10.0 wt %. Such PLA polymers are known to have lower crystallization rates as compared to pure L-PLA or pure D-PLA. PLA polymer production having a D-lactide isomer content above about 10.0 wt % typically cannot be crystallized industrially and will stay amorphous. In certain preferred embodiments of a process of the invention, a PLA polymer melt is provided, wherein the PLA polymer has a content of D-lactide isomer of between 1.5 and 8.0 wt %, such as between 2.0 and 6.0 wt %, or between 2.0 and 4.5 wt %, of said PLA polymer.

The present process involves the addition of a low concentration of an amide as defined herein at the melt processing stage of a PLA polymer, i.e. prior to pelletizing. The inventors have surprisingly shown that by adding a small amount of such compound at the melt stage (i.e. before pelletizing), it was possible to enhance, in subsequent crystallization steps, the speed of crystallization and to reduce the crystallization time. This also enables to reduce the size of crystallizer equipment required to prepare crystallised PLA pellets. Moreover, the present process permits to avoid problems with blocking of equipment due to stickiness of the PLA and/or inefficient crystallization of the PLA polymer. The present invention enables to produce different types of PLA having a desired degree of crystallinity at higher production rates, with minimal to no process upsets or shut-downs.

Preferably the amide added in the present process comprises at least one compound of formula (I) and/or at least one compound of formula (II),

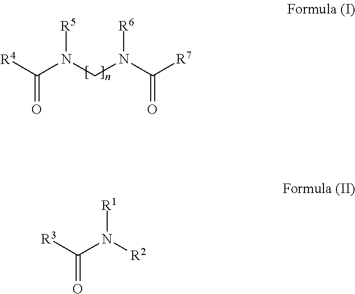

wherein each of R¹, R², R⁵, and R⁶ is independently hydrogen or is selected from the group comprising alkyl and alkenyl, wherein each group can be unsubstituted or substituted with one or more hydroxyl groups, and
wherein each of R³, R⁴ and R⁷ is independently selected from the group comprising alkyl and alkenyl, wherein each group can be unsubstituted or substituted with one or more hydroxyl groups, and
wherein n is an integer selected from 1, 2, 3, 4, 5, 6, or 7.

In certain embodiments of a process of the invention, said amide is selected from the group consisting of a saturated fatty acid bisamide, an unsaturated fatty acid bisamide, a saturated fatty acid monoamide, an unsaturated fatty acid monoamide, an N-alkyl substituted fatty acid monoamide, and any mixtures thereof.

In certain preferred embodiments of a process of the invention, said amide is a saturated fatty acid bisamide, and preferably a saturated fatty acid bisamide of formula (I), wherein R⁵ and R⁶ are hydrogen, wherein each of R⁴ and R⁷ is independently a C₄₋₂₈alkyl, which can be unsubstituted or substituted with one or more hydroxyl groups, and wherein n is an integer selected from 1, 2, 3, 4, 5, 6, or 7.

In certain embodiments of the present process, amide is added to said PLA polymer melt before step b) in the form of a composition consisting of amide as herein defined. Thus, in such embodiments, amide is added to the PLA polymer melt before step b) in the form of amide compound as such. In such embodiments, amide is added to the PLA polymer melt before the pelletizing step in the form of compound, and is not admixed with any non-amide compounds.

In certain embodiments of the present process, amide is added to said PLA polymer melt before step b) in the form of a molten composition obtained by melt-blending amide, as defined herein with a PLA polymer. The PLA polymer used for blending with amide may be a non-crystallised or a crystallised PLA, and may or may not contain amide by itself.

In certain embodiments of the present process, amide is added to the PLA polymer melt before step b) in the form of a previously crystallized PLA polymer which contains amide. For example, amide may be added in the form of a composition consisting of a previously crystallized PLA polymer amide. In such embodiments, the previously crystallised PLA is characterised in that it:
has a degree of crystallinity, prior to addition to the process of the invention, of at least 20.0%, such as at least 25.0%, or at least 30.0%, or at least 35.0%, or at least 40.0%, whereby said degree of crystallinity is determined according to the method specified herein;
has a content of D-lactide isomer equal to or lower than 10.0 wt % based on said previously crystallised PLA, such as between 0 and 10 wt %, or between 0.1 and 9.0 wt %, or between 0.5 and 8.0 wt %; or between 1.0 and 6.0 wt %, or between 2.0 and 4.5 wt %, and
contains amide, preferably as defined herein, in an amount of between 10 and 2000 ppm, or between 20 and 1500 ppm, or between 30 and 1000 ppm, or between 50 and 900 ppm, or between 100 and 900 ppm, with ppm based on the weight of the previously crystallised PLA.

In certain preferred embodiments, a process is provided comprising the step of adding to the PLA polymer melt before step b)
i) amide, preferably as defined herein, and
ii) a previously crystallised PLA;
   wherein said previously crystallised PLA is characterised in that it:
has a degree of crystallinity, prior to addition to the process, of at least 20.0%, or at least 30.0%, or at least 35.0%, or at least 40.0%, whereby said degree of crystallinity is determined according to the method specified herein;
has a content of D-lactide isomer equal to or lower than 10.0 wt % based on said previously crystallised PLA, such as between 0 and 10 wt %, or between 0.1 and 9.0 wt %, or between 0.5 and 8.0 wt %; or between 1.0 and 6.0 wt %, or between 2.0 and 4.5 wt %, and
optionally contains amide, preferably as defined herein, in a total amount of at most 2000 ppm, with ppm based on the previously crystallised PLA, or at most 1800 ppm, or at most of 1500 ppm, or at most of 1000 ppm, or at most 850 ppm, or at most 500 ppm, with ppm based on the previously crystallised PLA.

The Applicant has shown that in addition to amide as defined herein, which as such improves crystallization rates, also the further addition of a previously crystallised PLA at the melt stage gives advantages.

A previously crystallised PLA may be added before step b) of a process of the invention to the PLA polymer melt at a feed rate of from 0.5 to 15.0%, such as from 1.0 to 12.0%, or from 2.0 to 10.0%, or from 2.5 to 7.5%, with % expressed as compared to the feed rate of the PLA polymer melt as provided in step a).

In certain embodiments of a process of the invention a previously crystallised PLA is added to the PLA polymer, i.e. the PLA polymer melt, before step b), wherein said previously crystallised PLA has a crystallinity degree of at least 20.0%, such as at least 25.0%, or at least 30.0%, or at least 35.0%, or at least 40.0%.

In certain embodiments of a process of the invention a previously crystallised PLA is added to the PLA polymer, i.e. the PLA polymer melt, wherein said previously crystallised PLA has a content of D-lactide isomer equal to or lower than 10.0 wt % of said crystallised PLA polymer, and preferably a content of D-lactide isomer of between 0 and 10.0 wt %, or between 0.1 and 9.0 wt %, or between 0.5 and 8.0 wt %, or between 1.0 and 6.0 wt %, or between 2.0 and 4.5 wt %.

In certain preferred embodiments of the invention a process is provided wherein the amide and the previously crystallised PLA, as defined herein, are added separately to said PLA polymer melt. In certain other preferred embodiments amide and previously crystallised PLA, as defined herein, are blended, preferably melt blended, to form a composition, preferably a molten composition, and said composition or molten composition is added to said PLA polymer melt, in particular, prior to pelletization thereof.

It is preferred that a previously crystallised PLA, as applied in a process of the invention, is a crystallised form of the PLA polymer melt provided in step a).

Preferably, the PLA polymer melt is provided in step a) at a temperature comprised between 16° and 240° C., preferably between 19° and 230° C.

In certain embodiments of the present process, crystallization (step c) is carried out at temperatures of between 9° and 130° C., preferably between 10° and 115° C. In certain preferred embodiments, the present invention provides a process for the preparation of crystallized polylactide (PLA), in particular crystallized PLA pellets, wherein the crystallization step (step c) involves a two-step crystallization. To that end, in certain preferred embodiments of a process of the invention, the PLA pellets are crystallized, preferably under dry air conditions, by the steps of:
c1) keeping the PLA pellets in motion for a suitable period of time at a temperature of between 9° and 130° C., thereby obtaining pre-crystallised PLA, whereby said pre-crystallised PLA preferably has a degree of crystallinity of at least 3.0%, preferably of at least 5.0%; and
c2) transporting the pre-crystallised PLA to a crystallization vessel, and maintaining said pre-crystallised PLA in said crystallization vessel for a suitable period of time at a temperature of between 9° and 130° C., thereby obtaining crystallised PLA, whereby said crystallised PLA preferably has a degree of crystallinity at least 20.0%, such as at least 25.0%, or at least 30.0%, or at least 35.0%, or at least 40.0%, such as from 20.0 to 60.0%, or from 35.0 to 55.0%, or from 35.0 to 50.0%.

Degree of crystallinity may be determined according to the method as specified in the example section.

In another aspect, the present invention provides crystallised PLA, in particular crystallized PLA pellets, obtainable or obtained by carrying out a process according to the invention, and preferably wherein the crystallised PLA pellets have:
a D-lactide isomer content of between 1.0 and 10.0 wt %, such as between 1.5 and 8.0 wt %, or between 2.0 and 6.0 wt %, or between 2.0 and 4.5 wt %, based on the crystallised PLA; and
a degree of crystallinity of at least 20.0%, or at least 30.0%, or at least 35.0%, or at least 40.0%, wherein said degree of crystallinity is determined according to the method specified in the description; and
a total amount of amide, as defined in herein, of between 10 and 2000 ppm, such as between 20 and 1500 ppm, or between 30 and 1000 ppm, or between 50 and 900 ppm, or between 100 and 900 ppm, of the crystallised PLA pellets.

In another aspect, the present invention further relates to the use of an amide, as defined herein, for increasing the crystallization speed of a PLA polymer, in particular for increasing the crystallization speed of pellets of a PLA polymer, wherein said PLA polymer has a content of D-lactide isomer of between 1.0 and 10.0% by weight of said PLA polymer, wherein said amide is used in a melt of said PLA polymer, i.e. prior to pelletizing, in an amount between 10 and 2000 ppm of said PLA polymer melt. In embodiments, the invention relates to the use of amide, as defined herein, for increasing the crystallization speed of pellets of a PLA polymer as defined herein, wherein said amide is used to form prior to pelletizing a melt of said PLA polymer comprising amide in a total amount of between 10 and 2000 ppm of the PLA polymer melt, such as between 20 and 1500 ppm, or between 30 and 1000 ppm, or between 50 and 900 ppm, or between 100 and 900 ppm.

In certain preferred embodiments, amide is used in the form of a composition consisting of amide as defined herein, i.e. in the form of amide compound.

In other preferred embodiments, amide is used in the form of a composition consisting of a previously crystallized PLA polymer which contains amide, i.e. in the form of a previously crystallized PLA polymer which contains amide.

In other embodiments, amide is used in the form of a composition, obtained by melt-blending amide as defined herein with a PLA polymer, such as a PLA polymer which may be a non-crystallised or a crystallised PLA, and may or may not contain amide by itself. In certain preferred embodiments, the PLA polymer used for blending with amide is a crystallised PLA, which preferably contains amide.

In yet other preferred embodiments, amide is used in combination with a previously crystallized PLA polymer. Hence, in certain preferred embodiments, the present invention relates to the use of an amide as defined herein, in combination with a previously crystallised PLA, preferably as defined herein, for increasing the crystallization speed of pellets of a PLA polymer, wherein said amide and said previously crystallised PLA are added in a melt of said PLA polymer, i.e. prior to pelletizing, either separately, or as a blend, preferably as a molten composition.

In preferred embodiments, said previously crystallised PLA is used at a feed rate of from 0.5 to 15.0%, such as from 1.0 to 12.0%, or from 2.0 to 10.0%, or from 2.5 to 7.5%, with % expressed as compared to the feed rate of the PLA polymer melt

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### DETAILED DESCRIPTION OF THE FIGURES

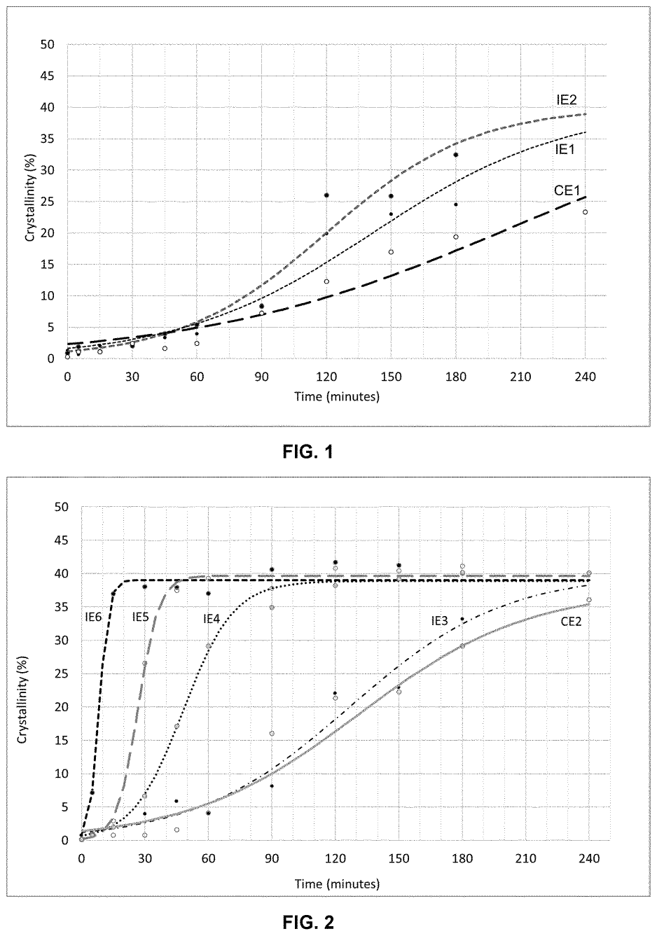

FIG. 1 illustrates the results of a crystallisation experiment carried out in accordance with Example 2.

FIG. 2 illustrates the results of a crystallisation experiment carried out in accordance with Example 3.

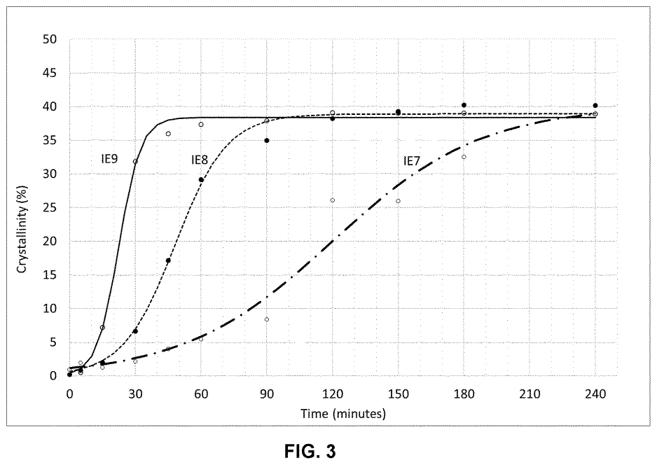

FIG. 3 illustrates the results of a crystallisation experiment carried out in accordance with Example 4.

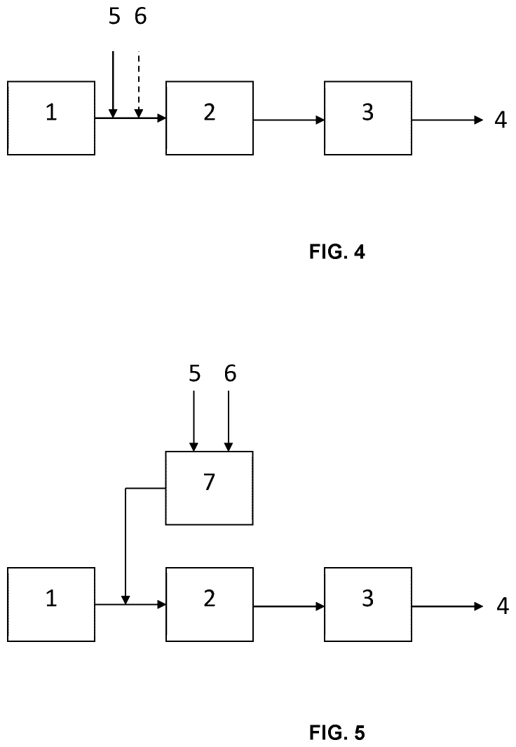

FIG. 4 is a schematic representation to illustrate a process for the preparation of crystallized polylactide (PLA) pellets in accordance with an exemplary embodiment of the present invention.

FIG. 5 is a schematic representation to illustrate a process for the preparation of crystallized polylactide (PLA) pellets in accordance with another exemplary embodiment of the present invention.

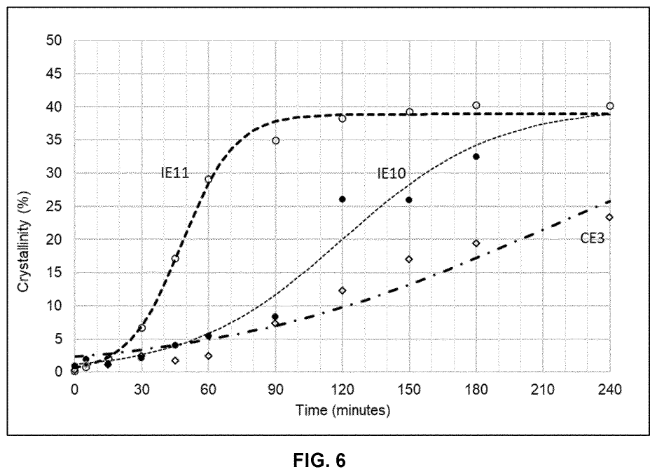

FIG. 6 illustrates the results of a crystallisation experiment carried out in accordance with Example 5.

### DETAILED DESCRIPTION OF THE INVENTION

When describing the invention, the terms used are to be construed in accordance with the following definitions, unless a context dictates otherwise.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while certain embodiments described herein include some but not other features included in other embodiments, combinations of features of different embodiments are meant to be within the scope of the invention, and form different embodiments, as would be understood by those in the art.

The terms “comprising”, “comprises” and “comprised of” as used herein are synonymous with “including”, “includes” or “containing”, “contains”, and are inclusive or open-ended and do not exclude additional, non-recited members, elements, or method steps. It will be appreciated that the terms “comprising”, “comprises” and “comprised of” as used herein comprise the terms “consisting of”, “consists” and “consists of”.

As used in the specification and the appended claims, the singular forms “a”, “an,” and “the” include plural referents unless the context clearly dictates otherwise. By way of example, “a step” means one step or more than one step.

Unless defined otherwise, all technical and scientific terms used herein have the same meaning as is commonly understood by one of skill in the art.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of endpoints also includes the end point values themselves (e.g. from 1.0 to 5.0 includes both 1.0 and 5.0). Any numerical range recited herein is intended to include all sub-ranges subsumed therein.

The term “about” as used herein when referring to a measurable value such as a parameter, an amount, a temporal duration, and the like, is meant to encompass variations of +/−10% or less, preferably +/−5% or less, more preferably +/−1% or less, of and from the specified value, insofar such variations are appropriate to perform in the disclosed invention. It is to be understood that the value to which the modifier “about” refers is itself also specifically, and preferably, disclosed.

The terms “wt %,” “vol %”, or “mol %” refers to a weight percentage of a component, a volume percentage of a component, or molar percentage of a component, respectively, based on the total weight, the total volume of material, or total moles, which includes the component.

When describing the present invention, the terms used are to be construed in accordance with the following definitions, unless a context dictates otherwise.

Preferred statements (features) and embodiments and uses of this invention are set herein below. Each statement and embodiment of the invention so defined may be combined with any other statement and/or embodiment unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered statements and embodiments, with any other aspect and/or embodiment.
1. Process for the preparation of crystallized polylactide (PLA), said process comprising the steps of:
   a) providing a PLA polymer melt, wherein the PLA polymer has a content of D-lactide isomer of between 1.0 and 10.0 wt % of said PLA polymer;
   b) processing said PLA polymer melt into PLA pellets, and
   c) crystallizing said PLA pellets thereby obtaining a crystallized PLA,
   wherein said process is characterised in that an amide is added to said PLA polymer melt in an amount of between 10 and 2000 ppm of the PLA polymer melt.
2. Process according to statement 1, wherein said amide is added to said PLA polymer melt prior to processing said PLA polymer melt into PLA pellets.
3. Process for the preparation of crystallized polylactide (PLA) pellets, said process comprising the steps of:
   a) providing a PLA polymer melt, wherein the PLA polymer has a content of D-lactide isomer of between 1.0 and 10.0 wt % of said PLA polymer,
   b) pelletizing the PLA polymer melt into PLA pellets, and
   c) crystallizing the PLA pellets, thereby obtaining crystallized PLA pellets, wherein said process is characterised in that amide is added to said PLA polymer melt before step b) to form a PLA polymer melt comprising amide in a total amount of between 10 and 2000 ppm of the PLA polymer melt.
4. Process for the preparation of crystallized polylactide (PLA) pellets, said process comprising the steps of:
   a) providing a PLA polymer melt, wherein the PLA polymer has a content of D-lactide isomer of between 1.0 and 10.0 wt % of said PLA polymer, and adding amide to the PLA polymer melt before step b) to form a PLA polymer melt comprising amide in a total amount of between 10 and 2000 ppm of the PLA polymer melt,
   b) pelletizing the PLA polymer melt, i.e. the PLA polymer melt comprising amide, formed in step a) into PLA pellets, and
   c) crystallizing the PLA pellets obtained in step b), thereby obtaining crystallized PLA pellets.
5. Process according to any one of the preceding statements, wherein the PLA pellets are crystallized by means of latent heat crystallisation.
6. Process according any one of the preceding statements, wherein during pelletizing the average PLA pellet temperature remains above the glass transition temperature (Tg) of the PLA polymer.
7. Process according to any one of the preceding statements, wherein said amide is added in an amount of between 20 and 1500 ppm, preferably between 30 and 1000 ppm, preferably between 50 and 900 ppm, preferably between 100 and 900 ppm, of the PLA polymer melt.
8. Process according to any one of the preceding statements, wherein said amide is added to form a PLA polymer melt comprising amide in a total amount of between 10 and 2000 ppm, or between 20 and 1500 ppm, or between 30 and 1000 ppm, or between 50 and 900 ppm, or between 100 and 900 ppm, of the PLA polymer melt.
9. Process according to any one of the previous statements, wherein said amide comprises at least one compound of formula (I) and/or at least one compound of formula (II),

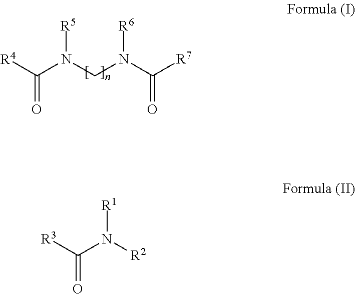

wherein each of R¹, R², R⁵, and R⁶ is independently hydrogen or is selected from the group comprising alkyl and alkenyl, wherein each group can be unsubstituted or substituted with one or more hydroxyl groups, and
wherein each of R³, R⁴ and R⁷ is independently selected from the group comprising alkyl and alkenyl, wherein each group can be unsubstituted or substituted with one or more hydroxyl groups, and
wherein n is an integer selected from 1, 2, 3, 4, 5, 6, or 7.
10. Process according to any one of the previous statements, wherein said amide comprises at least one compound of formula (I) and/or at least one compound of formula (II),
   wherein each of R¹, R², R⁵, and R⁶ is independently hydrogen or is selected from the group comprising C₁₋₂₈alkyl and C₂₋₂₈alkenyl, wherein each group can be unsubstituted or substituted with one or more hydroxyl groups, and
   wherein each of R³, R⁴ and R⁷ is independently selected from the group comprising C₁₋₂₈alkyl and C₂₋₂₈alkenyl, wherein each group can be unsubstituted or substituted with one or more hydroxyl groups, and
   wherein n is an integer selected from 1, 2, 3, 4, 5, 6, or 7.
11. Process according to any one of the previous statements, wherein said amide is a fatty acid amide.
12. Process according to any one of the previous statements, wherein said amide is selected from the group consisting of a fatty acid bisamide, a fatty acid monoamide, an N-alkyl substituted fatty acid monoamide, and any mixtures thereof.
13. Process according to any one of the previous statements, wherein said amide is selected from the group consisting of a saturated fatty acid bisamide, an unsaturated fatty acid bisamide, a saturated fatty acid monoamide, an unsaturated fatty acid monoamide, an N-alkyl substituted fatty acid monoamide, and any mixtures thereof.
14. Process according to any one of the previous statements, wherein said amide comprises a fatty acid bisamide, and preferably a fatty acid bisamide of formula (I), wherein each of R⁵ and R⁶ is independently hydrogen or is selected from the group comprising C₄₋₂₈alkyl and C₄₋₂₈alkenyl, wherein each group can be unsubstituted or substituted with one or more hydroxyl groups, and
   wherein each of R⁴ and R⁷ is independently selected from the group comprising C₄₋₂₈alkyl and C₄₋₂₈alkenyl, wherein each group can be unsubstituted or substituted with one or more hydroxyl groups, and
   wherein n is an integer selected from 1, 2, 3, 4, 5, 6, or 7.
15. Process according to any one of the previous statements, wherein said amide comprises a fatty acid bisamide of formula (I), wherein R⁵ and R⁶ are hydrogen, wherein each of R⁴ and R⁷ is independently selected from the group comprising C₄₋₂₈alkyl and C₄₋₂₈alkenyl, wherein each group can be unsubstituted or substituted with one or more hydroxyl groups, and wherein n is an integer selected from 1, 2, 3, 4, 5, 6, or 7.
16. Process according to any one of the previous statements, wherein amide comprises a saturated fatty acid bisamide, preferably a saturated fatty acid bisamide of formula II),

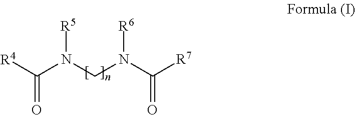

wherein R⁵ and R⁶ are hydrogen, wherein each of R⁴ and R⁷ is independently a C₄₋₂₈alkyl, which can be unsubstituted or substituted with one or more hydroxyl groups, and wherein n is an integer selected from 1, 2, 3, 4, 5, 6, or 7.
17. Process according to any one of the previous statements, wherein said amide is selected from the group consisting of ethylenebis stearamide, ethylenebis caprylic acid amide, ethylenebis capramide, ethylenebis lauramide, ethylenebis myristamide, ethylenebis palmitamide, ethylenebis isostearamide, ethylenebis behenamide, ethylenebis (12-hydroxystearamide), methylenebis caprylic acid amide, methylenebis capramide, methylenebis lauramide, methylenebis myristamide, methylenebis palmitamide, methylenebis stearamide, methylenebis isostearamide, methylenebis behenamide, methylenebis (12-hydroxystearamide), butylenebis stearamide, butylenebis behenamide, hexamethylenebis stearamide, butylenebis (12-hydroxystearamide), hexamethylenebis behenamide, hexamethylenebis (12-hydroxystearamide), and N,N′-distearyl adipamide.
18. Process according to any one of the previous statements, wherein the PLA polymer has a content of D-lactide isomer of between 1.5 and 8.0 wt %, such as between 2.0 and 6.0 wt %, or between 2.0 and 4.5 wt %, of said PLA polymer.
19. Process according to any one of the previous statements wherein the PLA pellets are crystallized in step c) under dry air conditions.
20. Process according to any one of the previous statements, wherein said amide is added to said PLA polymer melt before step b) in the form of a composition consisting of amide, preferably amide as defined in any one of the preceding statements.
21. Process according to any one of the previous statements, wherein said amide is added to said PLA polymer melt before step b) in the form of a composition obtained by melt-blending amide, preferably as defined in any one of the previous statements, with a PLA polymer.
22. Process according to statement 21, wherein the PLA polymer is a non-crystallised PLA.
23. Process according to statement 21, wherein the PLA polymer is a previously crystallised PLA.
24. Process according to any one of statements 21 to 23, wherein the PLA polymer does not contain amide.
25. Process according to any one of statements 21 to 23, wherein the PLA polymer contains amide, preferably in a total amount of at most 2000 ppm, with ppm based on the PLA polymer, or at most 1800 ppm, or at most of 1500 ppm, or at most of 1000 ppm, or at most 850 ppm, or at most 500 ppm, with ppm based on the PLA polymer.
26. Process according to any one of the previous statements, wherein a previously crystallised PLA is added to the PLA polymer melt.
27. Process according to any one of the previous statements, wherein said previously crystallised PLA is added to said PLA polymer melt prior to processing (pelletising) of said PLA polymer melt into PLA pellets.
28. Process according to any one of the previous statements, comprising the step of adding (i) amide, and (ii) a previously crystallised PLA, to the PLA polymer melt before step b), wherein said previously crystallised PLA is characterised in that it:
   has a degree of crystallinity, prior to addition to the process, of at least 20.0%, whereby said degree of crystallinity is determined according to the method specified in the description;
   has a content of D-lactide isomer equal to or lower than 10.0 wt % based on said previously crystallised PLA, and
   optionally contains amide, preferably as defined in any one of the previous statements, in a total amount of at most 2000 ppm, with ppm based on the previously crystallised PLA, or at most 1800 ppm, or at most of 1500 ppm, or at most of 1000 ppm, or at most 850 ppm, or at most 500 ppm, with ppm based on the previously crystallised PLA.
29. Process according to statement 28, wherein the amide and the previously crystallized PLA, are separately added to the PLA polymer melt before step b).
30. Process according to any one of the previous statement 28, wherein the amide, and the previously crystallized PLA, are added in combination to the PLA polymer melt.
31. Process according to statement 28 or 30, wherein the amide, and previously crystallized PLA, are blended to form a composition, and preferably are melt blended to form a molten composition, and wherein said composition, and preferably said molten composition, is added to said PLA polymer melt before step b).
32. Process according to previous statement 31, wherein said composition, preferably said molten composition is added to the PLA polymer melt at a feed rate (e.g. in kg/h) of from 0.5 to 15.0%, such as from 1.0 to 12.0%, or from 2.0 to 10.0%, or from 2.5 to 7.5%, with % expressed as compared to the feed rate of the PLA polymer melt as provided in step a).
33. Process according to any one of statements 1 to 19, wherein amide is added to said PLA polymer melt before step b) in the form of a previously crystallised PLA, and wherein said previously crystallised PLA is characterised in that it:
   has a degree of crystallinity, prior to addition to the process, of at least 20.0%, whereby said degree of crystallinity is determined according to the method specified in the description;
   has a content of D-lactide isomer equal to or lower than 10.0 wt % based on said previously crystallised PLA, and
   contains amide, preferably as defined in any one of the previous statements, in an amount of between 10 and 2000 ppm, with ppm based on the weight of the previously crystallised PLA, such as between 20 and 1500 ppm, or between 30 and 1000 ppm, or between 50 and 900 ppm, or between 100 and 900 ppm.
34. Process according to any one of the previous statements, wherein said previously crystallised PLA has a crystallinity degree, prior to addition to the process, of at least 20.0%, such as at least 25.0%, or at least 30.0%, or at least 35.0%, or at least 40.0%, such as a crystallinity degree from 20.0 to 60.0%, or from 30.0 to 55.0%, or from 35.0 to 50.0%, or from 38.0 to 48.0%.
35. Process according to any one of the previous statements, wherein said previously crystallised PLA has a content of D-lactide isomer equal to or lower than 10.0 wt % of said crystallised PLA polymer, and preferably a content of D-lactide isomer of between 0 and 10.0 wt %, or between 0.1 and 9.0 wt %, or between 0.5 and 8.0 wt %, or between 1.0 and 6.0 wt %, or between 2.0 and 4.5 wt %.
36. Process according to any one of the previous statements wherein a previously crystallised PLA is added to the PLA polymer melt at a feed rate (e.g. in kg/h) of from 0.5 to 15.0%, such as from 1.0 to 12.0%, or from 2.0 to 10.0%, or from 2.5 to 7.5%, with % expressed as compared to the feed rate of the PLA polymer melt as provided in step a).
37. Process according to any one of the previous statements, wherein the previously crystallized PLA is a crystallised form of the PLA polymer melt provided in step a).
38. Process according to any one of the previous statements, wherein the PLA polymer melt is provided in step a) at a temperature comprised between 16° and 240° C., preferably between 19° and 230° C.
39. Process according to any one of the previous statements, wherein the PLA pellets are crystallized, preferably under dry air conditions, by the steps of:
   c1) keeping the PLA pellets in motion for a suitable period of time at a temperature of between 9° and 130° C., thereby obtaining pre-crystallised PLA,
   c2) transporting the pre-crystallised PLA via a suitable conveying system, to a crystallization vessel, and maintaining said pre-crystallised PLA in said crystallization vessel for a suitable period of time at a temperature of between 9° and 130° C., thereby obtaining crystallised PLA,
40. Process according to any one of the previous statements, wherein the PLA pellets are subjected during step c1) to a temperature of between 90 to 120° C., preferably between 95 and 115° C., or between 10° and 115° C.
41. Process according to any one of the previous statements, whereby the pre-crystallised PLA obtained in step c1) has a degree of crystallinity of at least 3.0%, and preferably of at least 5.0%.
42. Process according to any one of the previous statements, wherein the pre-crystallised PLA is maintained in step c2) at a temperature of between 90 to 120° C., such as between 95 and 115° C., or between 10° and 115° C.
43. Process according to any one of the previous statements, wherein the crystallised PLA obtained in step c2) has a degree of crystallinity of at least 20.0%, such as at least 25.0%, or at least 30.0%, or at least 35.0%, or at least 40.0%, such as from 20.0 to 60.0%, or from 35.0 to 55.0%, or from 35.0 to 50.0%.
44. Process according to any one of the previous statements, wherein the time required for obtaining a suitable crystallinity degree, and preferably a crystallinity degree as defined in statement 43, is reduced with at least 10%, or at least 15%, or at least 20%, or at least 25%, or at least 35%, or at least 50%, as compared to a process in which no amide is added to the PLA polymer melt.
45. Crystallised PLA, preferably crystallized PLA pellets, obtainable or obtained by carrying out a process according to any one of the previous statements.
46. Crystallised PLA according to the previous statement, having
   a D-lactide isomer content of between 1.0 and 10.0 wt %, such as between 1.5 and 8.0 wt %, or between 2.0 and 6.0 wt %, or between 2.0 and 4.5 wt %, based on the crystallised PLA; based on the crystallised PLA; and
   a degree of crystallinity of at least 20.0%, or at least 30.0%, or at least 35.0%, or at least 40.0%, and for instance from 20.0 to 60.0%, or from 35.0 to 55.0%, or from 35.0 to 50.0%; and
   an amount of amide, as defined in herein, of between 10 and 2000 ppm of the crystallised PLA, such as between 20 and 1500 ppm, or between 30 and 1000 ppm, or between 50 and 900 ppm, or between 100 and 900 ppm.
47. Crystallised PLA pellets, obtainable or obtained by carrying out a process according to any one of the previous statements, wherein said pellets have
   a D-lactide isomer content of between 1.0 and 10.0 wt %, such as between 1.5 and 8.0 wt %, or between 2.0 and 6.0 wt %, or between 2.0 and 4.5 wt %, based on the crystallised PLA; and
   a degree of crystallinity of at least 20.0%, or at least 30.0%, or at least 35.0%, or at least 40.0%, wherein said degree of crystallinity is determined according to the method specified in the description; and
   a total amount of amide, as defined in any one of the preceding statements, of between 10 and 2000 ppm, such as between 20 and 1500 ppm, or between 30 and 1000 ppm, or between 50 and 900 ppm, or between 100 and 900 ppm, of the crystallised PLA pellets.
48. Use of an amide, as defined in any one of the previous statements, for increasing the crystallization speed of a PLA polymer, preferably pellets of a PLA polymer, wherein said PLA polymer has a content of D-lactide isomer of between 1.0 and 10.0% by weight of said PLA polymer, wherein said amide is used to form, prior to pelletizing, a melt of said PLA polymer comprising amide in a total amount of between 10 and 2000 ppm of said PLA polymer.
49. Use of an amide according to previous statement 48 for increasing the crystallization speed of a PLA polymer, preferably pellets of a PLA polymer, wherein said PLA polymer has a content of D-lactide isomer of between 1.5 and 8.0 wt %, or between 2.0 and 6.0 wt %, or between 2.0 and 4.5 wt %, of said PLA polymer.
50. Use of an amide according to any one of the previous statements for increasing the crystallization speed of a PLA polymer, preferably pellets of a PLA polymer, wherein said amide is used in a melt of said PLA polymer in an amount of between 20 and 1500 ppm, preferably between 30 and 1000 ppm, and more preferably between 50 and 900 ppm, or preferably between 100 and 900 ppm, of said PLA polymer.
51. Use of an amide according to any one of the previous statements, for increasing the crystallization speed of a PLA polymer, preferably pellets of a PLA polymer, wherein said amide is used in combination with a previously crystallised PLA, preferably a previously crystallised PLA as defined in any one of the previous statements
52. Use of an amide according to the previous statement 51 for increasing the crystallization speed of a PLA polymer, preferably pellets of a PLA polymer, wherein said amide and said previously crystallised PLA are separately added in a melt of said PLA polymer, and preferably wherein said previously crystallised PLA is used at a feed rate of from 0.5 to 15.0%, such as from 1.0 to 12.0%, or from 2.0 to 10.0%, or from 2.5 to 7.5%, with % expressed as compared to the feed rate of the PLA polymer melt.
53. Use of an amide according to previous statement 51 for increasing the crystallization speed of a PLA polymer, preferably pellets of a PLA polymer, wherein said amide and said previously crystallised PLA are added as a blend, preferably as a molten composition, in a melt of said PLA polymer, and preferably wherein said molten composition of said amide and said previously crystallised PLA is used a feed rate (e.g. in kg/h) of from 0.5 to 15.0%, such as from 1.0 to 12.0%, or from 2.0 to 10.0%, or from 2.5 to 7.5%, with % expressed as compared to the feed rate of the PLA polymer melt.

In one aspect, the present invention relates to a process for the preparation of crystallized polylactide (PLA), and in particular for the preparation of crystallized PLA pellets, i.e. crystallised PLA which is in pellet form. The present invention is directed to a process in which PLA polymer is first pelletized before being crystallized.

In one embodiment, the present invention relates to a process for the preparation of crystallized polylactide (PLA), comprising the steps of:
a) providing a melt of a PLA polymer (i.e. a PLA polymer melt), wherein the PLA polymer has a content of D-lactide isomer of between 1.0 and 10.0 wt % of said PLA polymer;
b) processing said PLA polymer melt into PLA pellets, and
c) crystallizing said PLA pellets, preferably under dry air conditions, thereby obtaining a crystallized PLA,

Said process is characterised in that an amide is added to said PLA polymer melt in an amount of between 10 and 2000 ppm of the PLA polymer melt.

In embodiments of the present invention, a process for the preparation of crystallised polylactide (PLA) pellets is provided comprising the steps of:
a) providing a PLA polymer melt, wherein the PLA polymer has a content of D-lactide isomer of between 1.0 and 10.0 wt % of said PLA polymer and adding amide to said PLA polymer melt in an amount of between 10 and 2000 ppm of the PLA polymer melt,
b) pelletizing the PLA polymer melt obtained in step a) into PLA pellets, and
c) crystallizing the PLA pellets obtained in step b), thereby obtaining crystallized PLA pellets.

When reference is made herein to the addition of amide to the PLA polymer melt, this corresponds to the addition of amide to the PLA polymer melt before step b) (i.e., before pelletizing), and in suitable amounts in order to form a PLA melt comprising a total amount of amide as given herein, such as between 10 and 2000 ppm, with ppm based on the PLA polymer melt.

The present invention thus provides a process for the preparation of crystallised polylactide (PLA) pellets comprising the steps of:
a) providing a PLA polymer melt, wherein the PLA polymer has a content of D-lactide isomer of between 1.0 and 10.0 wt % of said PLA polymer and adding amide to said PLA polymer melt to form a PLA melt comprising amide in a total amount of between 10 and 2000 ppm of the PLA polymer melt,
b) pelletizing the PLA polymer melt comprising amide formed in step a) into PLA pellets, and
c) crystallizing the PLA pellets obtained in step b), thereby obtaining crystallized PLA pellets.

In other words, the present invention provides a process for the preparation of crystallised polylactide (PLA) pellets comprising the steps of:
a) preparing a melt of a PLA polymer having a content of D-lactide isomer of between 1.0 and 10.0 wt % and comprising amide in a total amount of between 10 and 2000 ppm of the PLA polymer melt, wherein the PLA melt is prepared by adding amide to said PLA polymer melt,
b) pelletizing the PLA polymer melt obtained in step a) into PLA pellets, and
c) crystallizing the PLA pellets obtained in step b) thereby obtaining crystallized PLA pellets.

In accordance with the processes of the invention, PLA polymer melt is shaped into a pellet form. The tacky and amorphous PLA polymer pellets are subsequently crystallized into crystallized PLA pellets. The present invention is characterized in that low amounts of amide, as defined herein, are added at the PLA melt stage to improve the crystallization rate of the PLA pellets, i.e., to increase the speed of crystallization of the PLA pellets. The present invention thus involves a process in which PLA polymer is first pelletized before being crystallized.

The terms “PLA,” “polylactide,” and “polylactic acid” and “PLA polymer” are used herein as synonyms.

A “PLA polymer” as used herein refers to a polymer of lactide (monomers). Lactide can exist in three different geometric structures, which have a diastereomeric relationship. The term “lactide” (or “lactide monomer”) as used herein may therefore be L-lactide (derived from two L-lactic acid molecules), D-lactide (derived from two D-lactic acid molecules), meso-lactide (derived from a L-lactic acid molecule and a D-lactic acid molecule), or a mixture of two or more of the above. A 50/50 mixture of L-lactide and D-lactide with a melting point of about 126° C. is often referred to in the literature as D,L-lactide or racemic lactide (and is also denoted as “rac-Lactide” or “racemic lactide” or “rac-lactide” herein). A PLA polymer as defined herein may thus be a polymer of lactide selected from the group comprising L-lactide, D-lactide, meso-lactide, racemic lactide and any mixture of two or more thereof.

In accordance with the present invention, the PLA polymer applied in the present process has a stereochemical purity (called isomeric purity) of the L isomer which is between 90.0 and 99.0 wt % of the PLA. In other words, a PLA polymer as used in the invention has a content of D-lactide isomer which is between 1.0 and 10.0 wt %. The terms “D-lactide isomer” and “D-lactide” and “D-lactate isomer” are used herein as synonyms. A person skilled in the art will understand that the term “D-lactide isomer” as used herein refers to D-units that may originate from, i.e. be present through, D-lactide and/or mesolactide, or be generated through racemization. During analysis, the PLA chain is broken down to lactates and measured as such.

In certain embodiments, the PLA used in the present process has a content of D-lactide isomer of between 1.5 and 8.0 wt %, or of between 2.0 and 6.0 wt %, or of between 2.0 and 4.5 wt % of said PLA polymer. Examples of PLA polymers for use in a process according to the invention include for instance PLA having a D-lactide content of 1.5 or 2.0 or 2.5 or 3.0 or 3.5 or 4.0 or 4.5 or 5.0 or 5.5 or 6.0 wt % based on said PLA. Stereochemical purity may be determined using methods known in the art, such as methine-decoupled 1H-NMR spectroscopy and chiral column chromatography of methyl lactates (after methylation of the original PLA sample).

Processes for preparing PLA having the above defined isomeric purity are well-known by the person skilled in the art. For example, in an embodiment, the PLA is obtained by polymerizing lactide monomers, in the presence of a suitable catalyst and preferably in the presence of a compound of formula (III), acting as a co-initiator and transfer agent of the polymerization,

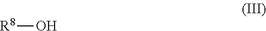

wherein R⁸ is selected from the group comprising C₁₋₂₀alkyl, C₆₋₃₀aryl, and C₆₋₃₀arylC₁₋₂₀alkyl optionally substituted by one or more substituents selected from the group comprising halogen, hydroxyl, and C₁₋₆alkyl. Preferably, R⁸ is selected from C₃₋₁₂alkyl, C₆₋₁₀aryl, and C₆₋₁₀arylC₃₋₁₂alkyl, optionally substituted by one or more substituents, each independently selected from the group comprising halogen, hydroxyl, and C₁₋₆alkyl; preferably, R¹ is selected from C₃₋₁₂alkyl, C₆₋₁₀aryl, and C₆₋₁₀arylC₃₋₁₂alkyl, optionally substituted by one or more substituents, each independently selected from the group comprising halogen, hydroxyl and C₁₋₄alkyl. The alcohol can be a polyol such as diol, triol or higher functionality polyhydric alcohol. The alcohol may be derived from biomass such as for instance glycerol or propanediol or any other sugar-based alcohol such as for example erythritol. The alcohol can be used alone or in combination with another alcohol.

Non-limiting examples of initiators include 1-octanol, isopropanol, propanediol, trimethylolpropane, 2-butanol, 3-buten-2-ol, 1,3-butanediol, 1,4-butanediol, 1,6-hexanediol, 1,7-heptanediol, benzyl alcohol, 4-bromophenol, 1,4-benzenedimethanol, and (4-trifluoromethyl)benzyl alcohol; preferably, said compound of formula (I) is selected from 1-octanol, isopropanol, and 1,4-butanediol.

The monomers used in the manufacture of a polylactide as defined herein for use in the present invention include L-lactic acid, D-lactic acid, L-lactide formed from two L-lactic acids, D-lactide formed from two D-lactic acids, and Meso-lactide formed from L-lactic acid and D-lactic acid.

Examples of a suitable catalyst for use in the aforementioned polymerization may include but are not limited to oxides of metals from Groups IV, V, VIII of the Periodic table, halogenide or carboxylate, such as antimony trioxide (Sb₂O₃), zirconium or titanium tris(phenolates), stannous oxide (SnO), stannous dichloride (SnCl₂), and Stannous bis(2-ethylhexyl carboxylate) (Sn(Oct)₂). Dosage of the catalyst is determined based on the conditions of the polymerization reaction, and is well known to the skilled person.

PLA polymer obtained after polymerisation stage has an amorphous structure and a very tacky surface. This amorphous structure can be converted into a more crystalline state having greater alignment among its molecular chains in a thermal after-treatment step that is also referred to as crystallization. The present process addresses a process for preparing a crystallized PLA. Preferably, the present process addresses a process for preparing crystallized PLA pellets.

The term “crystallised PLA” or “crystallized PLA” as used herein intends to refer to a PLA or PLA product that has a degree of crystallinity of at least 20.0%, such as at least 25.0%. In certain preferred embodiments, a crystallised PLA as prepared herein may have a degree of crystallinity of at least 30.0%, or least 35.0% or at least 40.0%.

The degree of crystallinity may be defined as the percentage of the crystalline part with respect to the overall internal structure of the polymer (i.e., crystalline and amorphous). The degree of crystallinity may be determined with techniques well known in the art, and as explained in the example section below.

In certain preferred embodiments, the preferred degree of crystallinity of the crystallised PLA prepared according to the present process is from 20.0 to 60.0%, such as from 30.0 to 60.0%, or from 35.0 to 55.0%, or from 35.0 to 50.0%. In an example the degree of crystallinity of the crystallised PLA prepared according to the present process may be from 38.0 to 48.0%, or from 40.0 to 45.0%. The process of the invention is characterised by providing a fast crystallization rate and a high degree of crystallinity.

The first step in the present process thus involves the provision of a PLA polymer melt.

A “PLA polymer melt” or “PLA melt” as used herein refers to a PLA polymer, as defined herein, which is in a molten state. The process of the invention involves the step of providing PLA polymer melt of the aforementioned PLA polymer, and by adding an amide to said PLA polymer melt, prior to subjecting said PLA polymer melt to a pelletizing step. The melt of PLA polymer may be provided by any suitable means, e.g. by supplying the polylactide formed by polymerization of the aforementioned lactide monomers to a suitable mixing device or vessel, e.g. static mixer or the like. Preferably a PLA polymer melt is provided in the present process at a temperature of about 160 to 240° C. In certain preferred embodiments, the PLA polymer melt is provided at a temperature comprised between 19° and 230° C.

In preferred embodiment of the present process, the PLA polymer melt provided in step a) is obtained by a process involving the steps of
i. subjecting lactide monomers to a polymerisation reaction in the presence of a suitable catalyst, preferably a catalyst as mentioned herein, and optionally a co-initiator, preferably a co-initiator as mentioned herein, to form a reaction mixture comprising polylactide,
ii. stabilizing such reaction mixture comprising polylactide by addition of a catalyst deactivator,
iii. degassing the reaction mixture to obtain a PLA polymer melt (i.e. polylactide as a molten residue), and
iv. retrieving the PLA polymer melt.

Catalyst deactivators are known in the art. The process of the invention is in particular characterised in that low amounts of an amide as defined herein is added to the PLA polymer melt, i.e. before processing (pelletizing) said PLA polymer melt into PLA pellets. Addition of such compound has been shown to improve/increase crystallization speed of a PLA (as defined herein), despite the low amounts used for such compound.

In preferred embodiments of the process of the invention, said amide comprises at least one compound of formula (I) and/or at least one compound of formula (II),

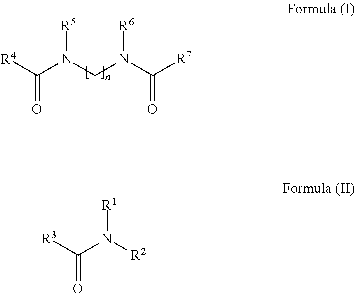

wherein each of R¹, R², R⁵, and R⁶ is independently hydrogen or is selected from the group comprising alkyl and alkenyl, wherein each group can be unsubstituted or substituted with one or more hydroxyl groups, and
wherein each of R³, R⁴ and R⁷ is independently selected from the group comprising alkyl and alkenyl, wherein each group can be unsubstituted or substituted with one or more hydroxyl groups, and
wherein n is an integer selected from 1, 2, 3, 4, 5, 6, or 7.

In preferred embodiments of the process of the invention, said amide comprises at least one compound of formula (I) and/or at least one compound of formula (II),
wherein each of R¹, R², R⁵, and R⁶ is independently hydrogen or is selected from the group comprising C₁₋₂₈alkyl and C₂₋₂₈alkenyl, wherein each group can be unsubstituted or substituted with one or more hydroxyl groups, and
wherein each of R³, R⁴ and R⁷ is independently selected from the group comprising C₁₋₂₈alkyl and C₂₋₂₈alkenyl, wherein each group can be unsubstituted or substituted with one or more hydroxyl groups, and
wherein n is an integer selected from 1, 2, 3, 4, 5, 6, or 7.

In certain embodiments of the process of the invention, said amide comprises a compound of formula (II), wherein R¹, R² and R³ are each independently selected from the group comprising C₁₋₂₈alkyl and C₂₋₂₈alkenyl, wherein each group can be unsubstituted or substituted with one or more hydroxyl groups.

In certain embodiments of the process of the invention, said amide comprises a compound of formula (II), wherein R¹ is hydrogen, and R² and R³ are each independently selected from the group comprising C₁₋₂₈alkyl and C₂₋₂₈alkenyl, wherein each group can be unsubstituted or substituted with one or more hydroxyl groups.

In certain embodiments of the process of the invention, said amide comprises a compound of formula (II), wherein R¹ and R² are hydrogen, and wherein R³ is selected from the group comprising C₁₋₂₈alkyl and C₂₋₂₈alkenyl, wherein each group can be unsubstituted or substituted with one or more hydroxyl groups.

In an example, said amide comprises a compound of formula (II), wherein R¹ and R² are hydrogen, and wherein R³ is a C₁₋₂₈alkyl, such as a C₁₋₂₂alkyl, or a C₁₋₁₈alkyl, or a C₁₋₁₂alkyl. In another example, said amide comprises a compound of formula (I), wherein R¹ and R² are hydrogen, and wherein R³ is a C₂₋₂₈alkenyl, such as a C₂₋₂₂ alkenyl, or a C₂₋₁₈ alkenyl, or a C₂₋₁₂ alkenyl.

In certain embodiments of the process of the invention, said amide comprises a fatty acid amide. The term “fatty acid amide” as used herein means an amide comprising in its structure at least one aliphatic hydrocarbon chain of at least 4 carbon atoms, such as from 4 to 28 carbon atoms, which may be saturated or unsaturated.

In certain embodiments of the process of the invention, said amide comprises a fatty acid bisamide. The term “fatty acid bisamide” as used herein refers to a compound having two amide bonds in one molecule, such as a saturated fatty acid bisamide, or an unsaturated fatty acid bisamide.

In certain preferred embodiments of the process of the invention, said amide comprises a fatty acid bisamide of formula (I),

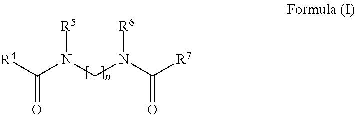

wherein each of R⁵ and R⁶ is independently hydrogen or is selected from the group comprising alkyl and alkenyl, wherein each group can be unsubstituted or substituted with one or more hydroxyl groups, and wherein each of R⁴ and R⁷ is independently selected from the group comprising alkyl and alkenyl, wherein each group can be unsubstituted or substituted with one or more hydroxyl groups, and wherein n is an integer selected from 1, 2, 3, 4, 5, 6, or 7.

In certain embodiments of the process of the invention, said amide comprises or consists of a fatty acid bisamide of formula (I), wherein each of R⁵ and R⁶ is independently hydrogen or is selected from the group comprising C₄₋₂₈alkyl and C₄₋₂₈alkenyl, wherein each group can be unsubstituted or substituted with one or more hydroxyl groups, and wherein each of R⁴ and R⁷ is independently selected from the group comprising C₄₋₂₈alkyl and C₄₋₂₈alkenyl, wherein each group can be unsubstituted or substituted with one or more hydroxyl groups, and wherein n is an integer selected from 1, 2, 3, 4, 5, 6, or 7.

In certain embodiments of the process of the invention, said amide comprises or consists of a fatty acid bisamide of formula (I), wherein R⁵ and R⁶ are hydrogen, wherein each of R⁴ and R⁷ is independently selected from the group comprising C₄₋₂₈alkyl and C₄₋₂₈alkenyl, wherein each group can be unsubstituted or substituted with one or more hydroxyl groups, and wherein n is an integer selected from 1, 2, 3, 4, 5, 6, or 7.

In certain embodiments of the process of the invention, said amide comprises or consists of a saturated fatty acid bisamide. In certain preferred embodiments of the process of the invention, said amide comprises a saturated fatty acid bisamide of formula (I), wherein R⁵ and R⁶ are hydrogen, wherein each of R⁴ and R⁷ is independently a C₄₋₂₈alkyl, which can be unsubstituted or substituted with one or more hydroxyl groups, and wherein n is an integer selected from 1, 2, 3, 4, 5, 6, or 7. Preferred examples of such saturated fatty acid bisamides, include but are not limited to ethylenebis stearamide, ethylenebis caprylic acid amide, ethylenebis capramide, ethylenebis lauramide, ethylenebis myristamide, ethylenebis palmitamide, ethylenebis isostearamide, ethylenebis behenamide, ethylenebis (12-hydroxystearamide), methylenebis caprylic acid amide, methylenebis capramide, methylenebis lauramide, methylenebis myristamide, methylenebis palmitamide, methylenebis stearamide, methylenebis isostearamide, methylenebis behenamide, methylenebis (12-hydroxystearamide), butylenebis stearamide, butylenebis behenamide, hexamethylenebis stearamide, butylenebis (12-hydroxystearamide), hexamethylenebis behenamide, hexamethylenebis (12 hydroxystearamide), and N,N′-distearyl adipamide.

In certain embodiments of the process of the invention said amide comprises or consists of a unsaturated fatty acid bisamide. In certain preferred embodiments, said amide comprises an unsaturated fatty acid bisamide of formula (I), wherein R⁴ and R⁷ are each independently selected from C₄₋₂₈alkenyl, optionally substituted by one of more hydroxyl groups, wherein R⁵ and R⁶ are hydrogen, and wherein n is an integer selected from 1, 2, 3, 4, 5, 6, or 7. Preferred examples of such unsaturated fatty acid bisamide, include but are not limited to for instance ethylenebis oleamide, ethylenebis erucamide, methylenebis oleamide, methylenebis erucamide, butylenebis oleamide, butylenebis erucamide, hexamethylenebis oleamide, hexamethylenebis erucamide, and N,N′-dioleyl-adipamide.

In certain embodiments of the process of the invention, said amide comprises or consists of a fatty acid monoamide. The term “fatty acid monoamide” as used herein refers to an amide compound comprising in its structure one aliphatic hydrocarbon of at least 4 carbon atoms, and preferably from 4 to 28 carbon atoms which may be saturated, i.e. a “saturated fatty acid monoamide”, or unsaturated, i.e. a “unsaturated fatty acid monoamide”.

In certain preferred embodiments of the process of the invention, said amide comprises a fatty acid monoamide of formula (II),

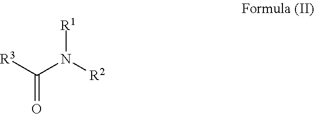

wherein each of R¹ and R² is independently hydrogen or is selected from the group comprising alkyl and alkenyl, wherein each group can be unsubstituted or substituted with one or more hydroxyl groups, and wherein R³ is selected from the group comprising alkyl and alkenyl, wherein each group can be unsubstituted or substituted with one or more hydroxyl groups.

In certain embodiments of the process of the invention, said amide comprises or consists of a fatty acid monoamide of formula (II), wherein each of R¹ and R² is independently hydrogen or is selected from the group comprising C₄₋₂₈alkyl and C₄₋₂₈alkenyl, wherein each group can be unsubstituted or substituted with one or more hydroxyl groups, and wherein R³ is selected from the group comprising C₄₋₂₈alkyl and C₄₋₂₈alkenyl, wherein each group can be unsubstituted or substituted with one or more hydroxyl groups.

In certain embodiments of the process of the invention, said amide comprises or consists of a saturated fatty acid monoamide. In certain preferred embodiments of the process of the invention, said amide comprises a saturated fatty acid monoamide of formula (II), wherein R¹ and R² are hydrogen, and wherein R³ is selected a C₄₋₂₈alkyl, which can be unsubstituted or substituted with one or more hydroxyl groups. Preferred examples of such saturated fatty acid monoamides, include but are not limited to lauramide, palmitamide, stearamide and 12-hydroxystearamide.

In certain embodiments of the process of the invention, said amide comprises or consists of an unsaturated fatty acid monoamide. In certain preferred embodiments of the process of the invention, said amide comprises an unsaturated fatty acid monoamide of formula (II), R¹ and R² are hydrogen, and wherein R³ is selected a C₄₋₂₈alkenyl, which can be unsubstituted or substituted with one or more hydroxyl groups. Preferred examples of such unsaturated fatty acid monoamides, include but are not limited to oleamide and erucamide.

In certain embodiments of the process of the invention, said amide comprises or consists of a N-alkyl substituted fatty acid monoamide. The term “N-alkyl substituted fatty acid monoamide” as used herein refers to a fatty acid monoamide, as defined herein (such as a saturated fatty acid monoamide or an unsaturated fatty acid monoamide) wherein one amide hydrogen of said fatty acid monoamide is substituted with an alkyl group. The N-alkyl substituted fatty acid monoamide as used herein thus includes “N-alkyl substituted saturated fatty acid monoamides” and “N-alkyl substituted unsaturated fatty acid monoamides.”

In certain preferred embodiments, said amide comprises or consists of a N-alkyl substituted fatty acid monoamide of formula (II),

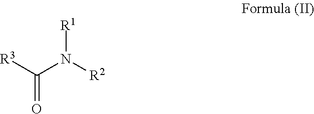

wherein R¹ is hydrogen, wherein R² is a C₁₋₂₈alkyl, optionally substituted with one or more hydroxyl groups, and wherein R³ is selected from the group comprising C₄₋₂₈alkyl and C₄₋₂₈alkenyl, wherein each group can be unsubstituted or substituted with one or more hydroxyl groups. Preferred examples of such N-alkyl substituted fatty acid monoamides, include but are not limited to N-lauryl lauramide, N-palmityl palmitamide, N-stearyl stearamide, N-behenyl behenamide, N-oleyl oleamide, N-stearyl oleamide, N-oleyl steararamide, N-stearyl erucamide, and N-oleyl palmitamide, methylol stearamide, N-stearyl-12-hydroxystearamide, N-oleyl-12-hydroxystearic stearamide, and the like.

In certain preferred embodiments of the process of the invention, the amide is selected from the group consisting of fatty acid bisamides, fatty acid monoamides, N-alkyl substituted fatty acid monoamides, and any mixtures thereof.

In certain preferred embodiments of the process of the invention, the amide is selected from the group consisting of a saturated fatty acid bisamide, an unsaturated fatty acid bisamide, a saturated fatty acid monoamide, an unsaturated fatty acid monoamide, an N-alkyl substituted fatty acid monoamide, and any mixtures thereof.

The total amount of amide added to the PLA polymer melt, hence present in the PLA polymer melt before pelletizing, is thus between 10 and 2000 ppm (i.e. 0.001 to 0.2 wt %) of the PLA polymer melt, and preferably between 20 and 1500 ppm (0.002 to 0.15 wt %), preferably between 30 and 1000 ppm (0.003 to 0.1 wt %), and more preferably between 50 and 900 ppm (0.005 to 0.09 wt %), and more preferably between 100 and 900 ppm (0.01 and 0.09 wt %), with ppm based on the weight of the PLA polymer melt.

Hence, the invention involves the preparation of melt of a PLA polymer, as defined herein, and comprising amide in a total amount of between 10 and 2000 ppm, or between 20 and 1500 ppm, or between 30 and 1000 ppm, or between 50 and 900 ppm, or between 100 and 900 ppm, with ppm based on the weight of the PLA polymer melt.

In preferred embodiments of the present invention, a process is provided for the preparation of crystallized polylactide (PLA) pellets, wherein the process involves the addition of amide to the PLA melt before step b) to form a PLA polymer melt having a total amount of amide of at most 2000 ppm, such as at most 1800 ppm, or at most 1500 ppm, or at most 1000 ppm, or at most 950 ppm, or at most 900 ppm, or at most 900 ppm, with ppm based on the PLA polymer melt. In preferred embodiments of the present invention, a process is provided for the preparation of crystallized polylactide (PLA) pellets, wherein the process involves the addition of amide to the PLA melt before step b) to form a PLA polymer melt having at least 15 ppm, or at least 25 ppm, or at least 50 ppm, or at least 100 ppm, or at least 150 ppm, or at least 300 ppm, or at least 400 ppm, with ppm based on the PLA polymer melt. In an example the (total) amount of amide in a PLA polymer melt is 100 ppm, or 200 ppm, or 300 ppm, or 400 ppm, or 500 ppm, or 600 ppm or 700 ppm, or 800 ppm, or 900 ppm, with ppm based on weight of the PLA polymer melt. The amide may be a single component or may also be a mixture of a plurality of components. In case of mixtures, the afore mentioned amounts intend to refer to the total amount of amide added to the PLA polymer melt in the present process.

The amide content (in ppm) in a sample can be determined by methods known to the skilled person. One method is for instance, it can be calculated from the nitrogen content of the sample by multiplying the content of nitrogen in ppm by the ratio of the molar mass of the amide over the molar mass of nitrogen (14 g/mol). The nitrogen content of a sample of the product can be determined in accordance with ASTM D4629. The sample is vaporized and carried to a high temperature zone where oxygen is introduced and organically bound nitrogen is converted to nitric oxide (NO). The NO contacts ozone and is converted to excited nitrogen dioxide (NO₂). The light emitted as the excited NO₂ decays is detected by a photomultiplier tube and the resulting signal is a measure of the nitrogen contained in the sample. Other methods for determining the amide content of a sample may be applied such as gas chromatography.

The Applicant has found that when the total concentration of amide in the PLA melt, and hence in the obtained PLA pellets is higher than 2000 ppm, issues may be observed when downstream processing the pellets into various applications. For instance, when using crystallised PLA pellets having a concentration of amide above 2000 ppm in downstream applications, e.g. in film blowing, sheet casting or thermoforming, unwanted or premature crystallization may occur. This affects processing efficiency and quality of the resulting products (films, sheets, etc). The present invention provides a valuable solution to such problems.

In the present processes, amide may be added in different forms to a PLA melt provided in step a).

In certain embodiments of the present invention the process involves the addition of amide to the PLA polymer melt before step b) in the form of a composition consisting of amide, i.e. in the form of amide compound. The present process thus involves in certain embodiments the addition of amide compound, i.e. as a separate compound, without the addition of other compounds or compositions, to the PLA polymer melt. For instance, amide compound can be added in liquid state, e.g. in the form of a melt, to the PLA melt before step b) of the process.

In certain embodiments of the present invention, the present process involves the addition of amide in the form of a masterbatch or masterbatch composition. The term “masterbatch” or “masterbatch composition” as used herein intends to refer to a composition consisting of a blend of amide and a PLA polymer. For instance, the masterbatch composition may be a molten composition obtained by melt-blending amide with a PLA polymer. The PLA polymer used for blending with amide to form a masterbatch composition may in principle by any type of PLA. It is however preferred that the PLA contains equal to or lower than 10.0 wt %, preferably equal to or lower than 8.0 wt %; or equal to or lower than 6.0 wt %; or equal to or lower than 4.5 wt %, of D-lactide isomer. In certain embodiments the PLA polymer, used to prepare the masterbatch, may be the same PLA polymer as provided in step a) of the present process.

In preferred embodiments, the PLA polymer, used for making a masterbatch composition with amide, is added to the PLA polymer melt at a feed rate (e.g. in kg/h) of from 0.5 to 15.0%, such as from 1.0 to 12.0%, or from 2.0 to 10.0%, or from 2.5 to 7.5%, with % expressed as compared to the feed rate of the PLA polymer melt as provided in step a).

In certain embodiments, the PLA polymer used for making a masterbatch composition with amide may be non-crystallised PLA. The term “non-crystallised” intends to refer to a PLA polymer which has not undergone a crystallization process. The terms “non-crystallised” and “amorphous” are used in the present description as synonyms.

In certain embodiments, the PLA polymer, used for making a masterbatch composition with amide, may be crystallised PLA, and preferably a previously crystallised PLA as defined herein.

In certain embodiments, the PLA polymer, used for making a masterbatch composition with amide, does not contain amide. In certain other embodiments, the PLA polymer, used for making a masterbatch composition with amide, contains in itself amide as well. If amide is present in the PLA polymer, it is preferably present in a total amount of at most 2000 ppm, with ppm based on the PLA polymer, or at most 1800 ppm, or at most of 1500 ppm, or at most of 1000 ppm, or at most 850 ppm, or at most 500 ppm, with ppm based on the PLA polymer.

In a preferred embodiment, the PLA polymer, used for making a masterbatch composition with amide, is a non-crystallised PLA, which does not contain amide. In an example, the present invention provides a process comprising the steps of:
a) providing a PLA polymer melt, wherein the PLA polymer has a content of D-lactide isomer of between 1.0 and 10.0 wt % of said PLA polymer,
b) pelletizing the PLA polymer melt obtained in step a) into PLA pellets, and
c) crystallizing the PLA pellets obtained in step b), optionally under dry air conditions, thereby obtaining crystallized PLA pellets,
wherein the process further comprises the steps of
   preparing a molten composition by melt blending amide with a PLA polymer, for instance a non-crystallised PLA not containing amide, and
   adding said molten composition to the PLA melt before step b) to form a PLA polymer melt having a total amount of amide of between 10 and 2000 ppm.

In another preferred embodiment, the PLA polymer, used for making a masterbatch composition with amide, is a previously crystallised PLA, which contains amide. In an example, the present invention provides a process comprising the steps of:
a) providing a PLA polymer melt, wherein the PLA polymer has a content of D-lactide isomer of between 1.0 and 10.0 wt % of said PLA polymer,
b) pelletizing the PLA polymer melt obtained in step a) into PLA pellets, and
c) crystallizing the PLA pellets obtained in step b), optionally under dry air conditions, thereby obtaining crystallized PLA pellets,
wherein the process further comprises the steps of
   preparing a molten composition by melt blending amide with a PLA polymer, for instance a previously crystallised PLA containing amide as provided herein, and
   adding said molten composition to the PLA melt before step b) to form a PLA polymer melt having a total amount of amide of between 10 and 2000 ppm.

The present process may also be described as comprising a step a) of preparing a melt of a PLA polymer having a content of D-lactide isomer of between 1.0 and 10.0 wt % and comprising amide in a total amount of between 10 and 2000 ppm, or between 20 and 1500 ppm, or between 30 and 1000 ppm, or between 50 and 900 ppm, or between 100 and 900 ppm, of the PLA polymer melt, wherein the PLA melt is prepared by adding to said PLA polymer melt a masterbatch composition consisting of amide as defined herein which is blended with a PLA polymer as defined herein.

The present process may in certain embodiments involve the addition to the PLA polymer melt before step b) of (i) amide, and (ii) a previously crystallized PLA polymer. In such embodiments, crystallised PLA obtained from a previous crystallization process may be fed to a PLA polymer at the PLA melt stage (i.e. prior to pelletization) in combination with amide, to further improve crystallization and crystallisation rate of the PLA polymer pellets. More specifically, the present invention provides a process wherein both amide compound and a previously crystallized PLA polymer are added to the PLA polymer melt before pelletizing thereof, either separately, or in combination as a mixture or blend, in order to form a PLA polymer melt comprising amide in a total amount as defined herein.

The term “previously crystallised PLA” as used in this context in the present invention intends to refer to a PLA polymer that has been previously crystallised, e.g. at some time in the past, using the process of the invention or using another method, and that is now mixed/added to the PLA polymer melt, i.e. before processing said PLA polymer melt into PLA pellets. In other words, in certain embodiments, a crystallised PLA (e.g. pellet) obtained from a first PLA polymer melt may be fed to a second PLA polymer melt in combination with amide compound.

It will be understood that in certain embodiments of the invention the term “previously crystallised PLA” and “crystallised PLA” may be used as synonyms. It will also be understood that said previously crystallised PLA, when added to the PLA polymer melt, may undergo remelting during the mixing step with the PLA polymer melt.

The previously crystallised PLA as defined herein is preferably added before step b) of the present process to the PLA polymer melt at a feed rate of from 0.5 to 15.0%, such as from 1.0 to 12.0%, or from 2.0 to 10.0%, or from 2.5 to 7.5%, with % expressed as compared to the feed rate of the PLA polymer melt as provided in step a).

The previously crystallised PLA for addition to the PLA melt is characterised in that it has a crystallinity degree of at least 20.0%, such as at least 25.0%, or at least 30.0%, or at least 35.0%, or at least 40.0%, such as for instance between 20.0 to 60.0%, or between 35.0 and 55.0%, or between 35.0 to 50.0%. It will be clear to the skilled person that when reference is made to the crystallinity degree of the previously crystallised PLA, it is meant to refer to the crystallinity degree as established (determined) for the previously crystallized PLA before it is added to the PLA polymer melt, thus before addition to the process. By blending the previously crystallised PLA with the PLA polymer melt before pelletising it, it will be understood that this previously crystallised material will undergo at least some melting which will result in a reduction—at least partially—of its crystallized structure. The crystallinity degree can be measured with the method as given in the example section.

In certain preferred embodiments said previously crystallised PLA for addition to the PLA melt is further characterised in that it has a content of D-lactide isomer equal to or lower than 10.0 wt % of said crystallised PLA polymer. The previously crystallised PLA has a content of D-lactide isomer of between 0 and 10.0 wt %, or between 0.5 and 8.0 wt %, or between 1.0 and 6.0 wt %, or between 2.0 and 4.5 wt %.

In an example, the previously crystallized PLA may be PLLA, i.e. PLA made from 100% L-lactide and having 0 wt % D-lactide, which has a crystallinity degree, as defined herein, of between 20.0 and 60.0%, or of between 35.0 and 55.0%, or of between 35.0 and 50.0%.

In another example, a previously crystallised PLA for addition to the PLA melt may include a PLA having a certain amount of D-lactide isomer, such as 0.5, or 1.0, 1.5, or 2.0, or 2.5, or 3.0, or 3.5, or 4.0, or 4.5, or 5.0, or 5.5, or 6.0 wt % D-lactide isomer based on said PLA (polymer) and a crystallinity degree, as defined herein, of between 20.0 and 60.0%. In another example, a previously crystallised PLA for addition to the PLA melt may include a PLA having a certain amount of D-lactide isomer, such as 0.5, or 1.0, 1.5, or 2.0, or 2.5, or 3.0, or 3.5, or 4.0, or 4.5, or 5.0, or 5.5, or 6.0 wt % D-lactide isomer based on said PLA (polymer) and a crystallinity degree, as defined herein, of between 35.0 and 55.0%. In another example, a previously crystallised PLA for addition to the PLA melt may include a PLA having a certain amount of D-lactide isomer, such as 0.5, or 1.0, 1.5, or 2.0, or 2.5, or 3.0, or 3.5, or 4.0, or 4.5, or 5.0, or 5.5, or 6.0 wt % D-lactide isomer based on said PLA (polymer) and a crystallinity degree, as defined herein, of between 35.0 and 50.0%.

In certain embodiments, the previously crystallised PLA which is added to the PLA polymer melt has a different composition as the PLA polymer of the PLA polymer melt. In certain embodiments, the previously crystallised PLA which is added to the PLA polymer melt has a different D-lactide content, as the PLA polymer of the PLA polymer melt.

In certain preferred embodiments, the previously crystallised PLA which is added to the PLA polymer melt has the same composition as the PLA polymer of the PLA polymer melt. Thus, in an example if a PLA polymer melt provided in step a) of the present process is a PLA having a D-lactide content of 4 wt %, it is preferred that the previously crystallised PLA polymer added to said PLA melt is a previously crystallised form of this same PLA.

The previously crystallised PLA may or may not contain amide, preferably contains amide. For instance, such previously crystallised PLA may have been prepared with a process of the invention.

In certain preferred embodiments, the previously crystallised PLA contains amide (as defined herein), in an amount of at most 2000 ppm, preferably at most 1800 ppm, preferably at most 1500 ppm, preferably at most 1000 ppm, more preferably at most 900 ppm, even more preferably at most 850 ppm, or at most 500 ppm, with ppm expressed based on the previously crystallised PLA. For instance, the previously crystallised PLA contains amide in amount of 400 ppm, or 500 ppm, or 600 ppm.

In an example, the present process, comprises the steps of:
a) preparing a melt of a PLA polymer having a content of D-lactide isomer of between 1.0 and 10.0 wt %; such as for instance between 2.0 and 6.0 wt %, and comprising amide in a total amount of between 50 and 900 ppm, of the PLA polymer melt, wherein the PLA melt is prepared by adding amide as defined herein and previously crystallized PLA containing amide, as defined herein to the PLA polymer melt,
b) pelletizing the PLA polymer melt obtained in step a) into PLA pellets, and
c) crystallizing the PLA pellets obtained in step b), optionally under dry air conditions, thereby obtaining crystallized PLA pellets.

In another example, the present process, comprises the steps of:
a) preparing a melt of a PLA polymer having a content of D-lactide isomer of between 2.0 and 4.5 wt %, and comprising amide in a total amount of between 100 and 900 ppm, of the PLA polymer melt, wherein the PLA melt is prepared by adding amide as defined herein and previously crystallized PLA containing amide, as defined herein to the PLA polymer melt,
b) pelletizing the PLA polymer melt obtained in step a) into PLA pellets, and
c) crystallizing the PLA pellets obtained in step b), optionally under dry air conditions, thereby obtaining crystallized PLA pellets.

In certain other embodiments of the present process it is preferred that amide is added to said PLA melt before step b) in the form of a previously crystallized PLA polymer which already contains amide. A “previously crystallised PLA containing amide”, as used in the below embodiment refers to a previously crystallised PLA as defined herein above, which contains amide, preferably as defined herein, in an amount of between 10 and 2000 ppm, or between 20 and 1500 ppm, or between 30 and 1000 ppm, or between 50 and 900 ppm, or between 100 and 900 ppm, with ppm based on the weight of the previously crystallised PLA.

For instance, the present process may provide a process comprising the steps of:
a) providing a PLA polymer melt, wherein the PLA polymer has a content of D-lactide isomer of between 1.0 and 10.0 wt % of said PLA polymer and adding a previously crystallised PLA containing amide to the PLA melt to form a PLA polymer melt having a total amount of amide of between 10 and 2000 ppm, such as between 20 and 1500 ppm, or preferably between 30 and 1000 ppm, or preferably between 50 and 900 ppm, or preferably between 100 and 900 ppm.
b) pelletizing the PLA polymer melt obtained in step a) into PLA pellets, and
c) crystallizing the PLA pellets obtained in step b), optionally under dry air conditions, thereby obtaining crystallized PLA pellets.

In an example, step a) of the present process may involve the step of providing a PLA polymer melt, wherein the PLA polymer has a content of D-lactide isomer of between 2.0 and 6.0 wt %, of said PLA polymer and adding a previously crystallised PLA containing amide to the PLA melt to form a PLA polymer melt having a total amount of amide of between 50 and 900 ppm.

In another example, step a) of the present process may involve the step of providing a PLA polymer melt, wherein the PLA polymer has a content of D-lactide isomer of between 2.0 and 4.5 wt %, of said PLA polymer and adding a previously crystallised PLA containing amide to the PLA melt to form a PLA polymer melt having a total amount of amide of between 100 and 900 ppm.

In such embodiments, the amide provided in the PLA melt thus originates from a previously crystallised PLA which already contains amide, and no further additional amide is separately or externally added to the PLA polymer melt in the process.

The addition of the indicated low amounts of amide(s) as defined herein, in particular to prepare a PLA polymer melt before pelletization having a low amide content, was shown to distinctly increase crystallization speed (crystallisation rate) of a PLA polymer, including PLA polymer pellets, and hence to considerably reduce the time needed to perform crystallization and obtain crystallised PLA and crystallised PLA pellets with a suitable degree of crystallinity. More specifically, the addition of amide as indicated herein permits to reduce the time required for obtaining a crystallised PLA (as defined herein) with at least 20%, such as at least 25%, or at least 35% or at least 50%, as compared to a process in which no amide is added to the PLA polymer melt.

This finding is unexpected. Despite the fact that amide is added in low amounts to the PLA polymer melt, i.e. to form a PLA polymer melt containing low amounts of amide, it is still very effective at improving the crystallization rate of a PLA polymer, and in particular of PLA polymer pellets. The present process therefore allows to deliver crystallized PLA pellets of good quality that exhibit desirable properties and easier handling. Crystallized PLA pellets obtained with the present process can also be easily stored, transported, or packaged. Another unexpected advantage of the present invention, is that the low amounts of amide as disclosed herein, do not affect the biodegradability and suitability for food contact applications of PLA products and articles made from crystallized PLA pellets of the invention.

In addition, surprisingly, the Applicants also found that the addition of a previously crystallised PLA, as defined herein, to a PLA polymer melt in the process of the invention, in addition to (on top of) amide which is also supplied in the present process (e.g. as a separate feed), further improves the crystallisation rate. In fact, it was shown that the addition of such previously crystallised PLA works in combination with amide (added as separate, external compound) as defined herein further increases the crystallisation rate of the PLA polymer pellets beyond the crystallisation rate that is obtained when adding amide without the previously crystallized PLA. The addition of a previously crystallised PLA in combination with amide in accordance with the present invention further promotes the formation and growth of nuclei (i.e., crystallites) in the PLA material (i.e. the PLA pellets).

Advantageously, it was also found that the addition of previously crystallised PLA (pellets), may further increase the crystallization rate of PLA pellets on top of the increase obtained by adding a composition consisting of amide (i.e. amide compound), and hence considerably reduces the time needed to perform crystallization of the pellets. The present invention is particularly useful as it may reduce the size of crystallization equipment and/or may require less (expensive) crystallization equipment.

Amide and/or previously crystallised PLA, both as defined herein, may be fed to a vessel or other equipment containing a PLA polymer melt by any suitable means, e.g. by means of a side feeder or the like.

Said components (amide and/or a previously crystallised PLA) can be added to the PLA polymer melt in solid state (e.g. in the form of a powder or pellets) or can be added to the PLA polymer melt in a molten state.

In certain embodiments of the present process, both the amide and the previously crystallised PLA are added, and both are added separately to the PLA polymer melt. Such embodiment is for instance illustrated in FIG. 4. In an example, amide as defined herein may be provided to the PLA polymer melt in a molten state, by combining it, for instance in dedicated side-extruder equipment, with amorphous (non-crystallised) PLA to form a melt (i.e. the amide can be dosed with said non-crystallised PLA), and then fed in molten state to the PLA polymer melt. The previously crystallised PLA as defined herein may also be provided to the PLA polymer melt in a molten state. For instance previously crystallised PLA may be provided in the form of pellets and fed to a dedicated side-extruder equipment to form a melt, and then fed in molten state to the PLA polymer melt.

The amide and the previously crystallised PLA may each be added separately to the PLA polymer melt at a feed rate (e.g. in kg/h) of from 0.5 to 15.0%, such as from 1.0 to 12.0%, or from 2.0 to 10.0%, or from 2.5 to 7.5%, with % expressed as compared to the feed rate of the PLA polymer melt. In an example, if PLA polymer melt is provided in the present process at a feed rate of about 10.000 kg/h, a previously crystallised PLA, as defined herein, may be fed to the PLA melt at a rate of about 200 to 500 kg/h (i.e. 2.0 to 5.0%). In another example, if PLA polymer melt is provided at a feed rate of about 8.000 kg/h, a previously crystallised PLA, as defined herein, may be fed to the PLA melt obtained in the process at a rate of about 200 to 600 kg/h (i.e. 2.5 to 7.5%).

In certain other embodiments of the present process, the amide and the previously crystallised PLA, both as defined herein, are added in combination to the PLA polymer melt. Such embodiment is for instance illustrated in FIG. 5. To that end, an amide as defined herein may be melt blended with the previously crystallised PLA (e.g. in dedicated side-extruder equipment) to form a molten composition, and then the molten composition is fed to said PLA polymer melt. In certain preferred embodiments, the process of the invention involves adding such molten composition of said amide and said previously crystallised PLA to the PLA polymer melt at a feed rate (e.g. in kg/h) of from 0.5 to 15.0%, such as from 1.0 to 12.0%, or from 2.0 to 10.0%, or from 2.5 to 7.5%, with % expressed as compared to the feed rate of the PLA polymer melt as provided in step a).

In accordance with the present process a PLA polymer melt is formed prior to pelletization, which has a total amount of amide of between 10 and 2000 ppm, such as between 20 and 1500 ppm, or preferably between 30 and 1000 ppm, or more preferably between 50 and 900 ppm, or more preferably between 100 and 900 ppm. The following examples illustrate how to determinate the total amount of amide in a PLA polymer melt, that is subjected to pelletization in accordance with embodiments of the present process.

In an example PLA polymer melt is provided at a feed rate of about 10.000 kg/h. Amide is directly injected in the PLA polymer flow at a rate of 5 kg/hr (i.e. 500 ppm), and a previously crystallised PLA, containing 500 ppm of amide, is separately and also directly injected in the PLA polymer melt at a feed rate of 15% of the feed rate of the PLA melt (i.e. at a rate of 1500 kg/h). The resulting PLA polymer melt feed (i.e. 11500 kg/h) is thus fed with 5.75 kg/hr of amide, corresponding to total amount of amide of 500 ppm in the PLA melt.

In another example, a PLA polymer melt is provided at a feed rate of about 10.000 kg/h. Amide is directly injected in the PLA polymer flow at a rate of 16.5 kg/hr (i.e. 1650 ppm), and a previously crystallised PLA, containing 500 ppm of amide, is separately injected in the PLA polymer melt at a feed rate of 15% of the feed rate of the PLA melt (i.e. at a rate of 1500 kg/h). The resulting PLA polymer melt feed (i.e. 11500 kg/h) is thus fed with 17.25 kg/hr of amide, corresponding to total amount of amide of 1500 ppm in the PLA melt.

In another example, a PLA polymer melt is provided at a feed rate of about 10.000 kg/h. Amide is directly injected in the PLA polymer flow at a rate of 5.5 kg/hr (i.e. 550 ppm), and a previously crystallised PLA, containing no ppm of amide, is separately injected in the PLA polymer melt at a feed rate of 10% of the feed rate of the PLA melt (i.e. at a rate of 1000 kg/h). The resulting PLA polymer melt feed (i.e. 11000 kg/h) is thus fed with 5.5 kg/hr of amide, corresponding to total amount of amide of 500 ppm in the PLA melt.

In a next step of the process of the invention (step b), the PLA polymer melt is subjected to a pelletization process to form PLA pellets.

Pelletization may be carried out according to techniques known in the art. For example, the PLA polymer melt may enter a die-face cutting pelletizer. Such a pelletizer generally includes a cooling medium, a plurality of extrusion holes, and a rotating face cutter. A strand cutting pelletizer is also suitable for use in the present process. Obtained PLA pellets may then be forwarded to a dewatering device or a dryer to remove moisture. Examples of suitable dewatering devices or dryers include for instance a centrifugal dryer, a vibrating screen, filter cloth, and the like.

As disclosed herein above, a PLA polymer melt is provided in the present process at a temperature of about 160 to 240° C. Preferably, the pelletization step is performed within a suitable temperature window such that the average PLA pellet temperature remains above the glass transition temperature (Tg) of the PLA polymer. The average PLA pellet temperature may be determined by techniques known to the skilled person.

Obtained PLA pellets are subsequently subjected to crystallization. It will be understood that in accordance with the present process, crystallisation step c) involves crystallization of the PLA pellets as such, i.e. crystallization is applied on the pellets as such and as directly obtained from the pelletizing step. The term “directly obtained” in that respect intends to indicate that PLA pellets (obtained in step b) are not subjected to any further processing step including for instance melting, moulding, extrusion, etc., before being subjected to crystallisation in step c). In accordance with the present invention, crystallisation step c) of the present method is applied directly on the PLA pellets as obtained in step b) of the present process.

In accordance with the present process, PLA pellets applied in step c) are not molten prior to or during crystallisation. In accordance with the present process, PLA pellets applied in step c) are not molded into articles (e.g. sheets, film, etc.) prior to or during crystallisation. In other words, the present process does not involve the crystallisation of a moulded article prepared from PLA pellets or from a molten form thereof.

Crystallization of the PLA pellets may be carried out in the present process under dry air conditions. “Dry air conditions” as used herein, means that dry air is added during crystallization steps in order to reduce the moisture of the PLA pellets and/or to prevent the PLA pellets to absorb additional moisture from the environment. As used herein, the term “dry air” or “dry air conditions” intends to refer to air that at atmospheric pressure has a dew point of about 5° C. or less. Preferably, the dry air as applied in the invention has a dew point of 0° C. or less, and preferably a dew point of −10° C. or less. In certain embodiments, dry air as applied in the invention may have a dew point of less than −20° C. to as low as −40° C.

In preferred embodiments of the invention a process is provided wherein the PLA pellets are crystallised by means of latent heat crystallisation. The term “latent heat crystallization” is in general well known in the art and refers to a process in which crystallization occurs by using the inherent (residual) heat in the polymer granulates. Latent heat crystallization in the context of the present invention therefore means that PLA pellets are crystallized directly from the melt, i.e. that crystallization occurs from the heat retained in the PLA polymer (in the pellet) after pelletization. In accordance with the present process, the average pellet temperature preferably does not fall below glass transition temperature. Advantageously, no heating step is required to start the crystallization of the PLA pellets.

The glass transition temperature, also known as Tg, is a critical temperature in the behaviour of amorphous polymers. The “glass transition temperature” of a polymer is well known in the art, and may be defined as the temperature at which a material undergoes a reversible phase transition from a rigid, glassy state to a more flexible, rubbery or viscous state. This transition is typically accompanied by significant changes in polymer chain mobility, molecular arrangement, and mechanical properties. The glass transition temperature (Tg) may be determined with techniques well known in the art (e.g. Differential Scanning Calorimetry (DSC)). Typical glass transition temperatures of a PLA polymer are situated between 50° C. and 60° C., mostly dependent on scanning speed during the DSC thermogram.

A particular advantage of the present process is that no additional energy supply (e.g. heating) is needed during pelletization and crystallization. For instance, it has been found that it is possible to transfer the PLA pellets from a pelletizer to a crystallizer without further heat input. With good process control, the “crystallization heat”, “heat of fusion”, or “latent crystallization heat” inherently present when transitioning from an amorphous molten state to a (partially) crystalline solid state was unexpectedly found to be sufficient to maintain a crystallization temperature for a suitable period of time. In other words, by keeping the PLA pellets within a (narrow) temperature range above the glass transition temperature (Tg) of the PLA polymer, no additional heating is required to facilitate reorganization of the PLA polymer chains into a crystalline structure. The PLA pellets may be kept at a crystallization temperature of between 9° and 130° C., preferably between 9° and 120° C., more preferably between 9° and 115° C., and most preferably between 10° and 115° C., without additional (external) heating.

In accordance with the present process, it is preferred that a two step-crystallization is applied.

A first step involves keeping the PLA pellets in motion for a suitable period of time while exposing the pellets to a crystallization temperature of between 9° and 130° C., preferably between 9° and 120° C., more preferably between 9° and 115° C., and most preferably between 105 and 110° C. The pellets are kept in motion so that they do not start to stick together. During this step, the PLA pellets will undergo crystallization to a certain degree so as to yield pre-crystallised PLA. Such pre-crystallised PLA preferably has a degree of crystallinity, as defined herein, of at least 3.0%, such as at least 3.5%, 4.0%, 5.0%, 5.5%, 6.0%, 6.5% or 7.0%. This first step is adapted to provide a pre-crystallization of the PLA pellets, to reduce their stickiness so that they can be subsequently transported and stored in suitable equipment.

Suitable systems to allow PLA pellets to remain in motion while being subjected to crystallisation temperatures are known in the art. Examples include but are not limited to vibratory conveyor device(s), continuous fluidized bed(s), rotating drums, paddle dryers, or the like. Such devices may be heated using e.g. hot air, infrared rays or other heating devices, depending on needs.

In accordance with the present invention, residence time during this (first) pre-crystallization phase can be limited to about 15-60 minutes, such as about 20-40 minutes. Even when applying such short residence times, a pre-crystallised PLA having a crystallinity degree of about 3% or more can already be obtained. At such crystallization degrees, tackiness of PLA pellets is greatly reduced or even absent, which further facilitates handling of the PLA pellets in the next crystallization step.

In a next step, the obtained pre-crystallised PLA is transported to a crystallization vessel, and maintained in said crystallization vessel for a suitable period of time at a temperature of between 9° and 130° C., such as between 90 to 120° C., or between 95 and 115° C., or between 10° and 115° C. In this step, crystallised PLA is obtained having a degree of crystallinity at least 20.0%, such as at least 25.0%, or at least 30.0%, or at least 35.0%, or at least 40.0%. In an example, the crystallised PLA obtained in the present process has a crystallisation degree from 20.0 to 60.0%, or from 35.0 to 55.0%, or from 35.0 to 50.0%.

A suitable example of a crystallisation vessel for use in the present invention may for instance comprise a silo; positioned in an upright position. Pre-crystallised pellets can enter the silo from above, and the effect of gravity causes the pellets to gradually move from the upper portion toward the lower portion of the silo. A valve may be provided at an outlet of the silo to control the rate of movement and discharge of the pellets. In accordance with the present invention, residence time during this (second) crystallization phase can be limited to less than 3 hours, such as less than 2 hours.

In some preferred embodiments, the first crystallization step, transportation to the crystallization vessel of the second crystallization step, and the second crystallization step are conducted at about a constant temperature.

In some preferred embodiments, the pelletization step and crystallization step of the present process are conducted within the same temperature range.

The obtained crystallized PLA may be subsequently cooled for storage and packaging.

The present process is further illustrated by reference to FIGS. 4 and 5. FIG. 4 shows a simplified diagram of an embodiment of a process of the invention, wherein amide and optionally previously crystallized PLA are separately fed to a PLA polymer melt. FIG. 5 shows a simplified diagram of another embodiment of a process of the invention, wherein amide and previously crystallized PLA are first blended into a molten composition and then fed to a PLA polymer melt.

Referring to FIGS. 4 and 5, the present process involves in a first step the supply of a PLA polymer melt (1), which may be for instance obtained from a PLA polymerization plant in which PLA was prepared by ring-opening polymerization of the corresponding lactide monomers, preferably in the presence of a suitable catalyst. The PLA polymer obtained after polymerization is fully molten. The PLA polymer obtained through such polymerization process may have a content of D-lactide isomer of between 1.0 and 10.0 wt %, for instance a D-lactide isomer content of 4 or 5 wt %. Preferably, the PLA polymer melt is provided at a temperature of about 160 to 240° C. The PLA polymer melt is then transferred, e.g. one or more via transfer lines, and after stabilization, to a pelletizing section (2) for producing PLA pellets. Prior to pelletization, an amide and optionally also a previously crystallised PLA, both as defined herein, may be fed to a vessel or other equipment (not shown) containing the PLA polymer melt by any suitable means, e.g. by means of a side feeder or the like. The vessel or other equipment containing the PLA polymer melt may be any suitable mixing device or vessel allowing blending of the PLA polymer melt with the amide and the previously crystallised PLA (if applied). Suitable mixing devices include but are not limited to melt kneaders such as a closed kneader, a single-screw or twin-screw extruder. In a preferred example, the mixing device may be a static mixer. In certain embodiments of the present process, such as illustrated in FIG. 4, amide compound (of formula I and/or II as defined herein) (5) and previously crystallised PLA (6), as defined herein, are added separately to the PLA polymer melt by any suitable means. The amide and previously crystallised PLA can be added to the PLA polymer melt as pure compounds or mixed and blended with another compound as masterbatch. For instance, the amide may be melt blended in suitable side-extruder equipment, with amorphous (non-crystallised) PLA, and the resulting blend may be fed in molten state to the PLA polymer melt.

In certain other embodiments of the present process, as illustrated in FIG. 5, the amide (5) (of formula I and/or II as defined herein) and the previously crystallised PLA (6) as defined herein, are first blended and then subsequently added together to the PLA polymer melt. For instance, the amide can be melt blended in suitable equipment (7), e.g. a side-feeder, with the previously crystallised PLA, and the resulting blend may be fed in molten state to the PLA polymer melt. The side feeder may be an extruder equipped with a downstream melt pump.

The resulting PLA polymer melt, hence containing amide, and eventually previously crystallised PLA, is then fed into a pelletizing section (2), to shape the PLA polymer into PLA pellets. Suitable pelletizers include for instance a die-face cutting pelletizer or strand cutting pelletizer. Optionally, the obtained PLA pellets may be forwarded to a dewatering device or a dryer to remove excess moisture.

The PLA pellets coming out of the pelletizing section are amorphous, which means that they will be soft and sticky above the glass transition temperature making them difficult to transport, store, process and dry. It is therefore preferred that cooling of the pellets is limited and that the crystallization process is started in the shortest possible time. PLA pellets are crystallised in the crystallization section (3), which may include any suitable crystallization equipment such as described herein above. Preferred crystallisation temperatures include temperatures of between 90° C. and 130° C., preferably between 9° and 120° C., more preferably between 9° and 115° C., and most preferably between 105 and 110° C.

The resulting crystallized PLA pellets may be collected and send to a storage and packaging section (4).

In another aspect, the present invention also relates to a crystallised PLA, and in particular crystallised PLA pellets, obtainable or obtained by carrying out a process according to the present invention.

In certain embodiments, crystallised PLA, obtainable or obtained according to the present invention is characterised in that
it has a D-lactide isomer content of between 1.0 and 10.0 wt %, such as between 1.5 and 8.0 wt %, or between 2.0 and 6.0 wt %, or between 2.0 and 4.5 wt %, based on the crystallised PLA; and
it has a degree of crystallinity of at least 20.0%, such as at least 25.0%, or at least 30.0%, or at least 35.0%, or at least 40.0%, and for instance from 20.0 to 60.0%, or from 35.0 to 55.0%, or from 35.0 to 50.0%; and
it contains an amount of amide, as defined in herein, of between 10 and 2000 ppm of the crystallised PLA, such as between 20 and 1500 ppm, or between 30 and 1000 ppm, or between 50 and 900 ppm, or between 100 and 900 ppm.

In certain embodiments, crystallised PLA pellets, obtainable or obtained according to the present invention are characterized in that said pellets have
a D-lactide isomer content of between 1.0 and 10.0 wt %, such as between 1.5 and 8.0 wt %, or between 2.0 and 6.0 wt %, or between 2.0 and 4.5 wt %, based on the crystallised PLA pellet; and
a degree of crystallinity of at least 20.0%, such as at least 25.0%, or at least 30.0%, or at least 35.0%, or at least 40.0%, and for instance from 20.0 to 60.0%, or from 35.0 to 55.0%, or from 35.0 to 50.0%; wherein said degree of crystallinity is determined according to the method specified in the present description, and
a total amount of amide, as defined herein, of between 10 and 2000 ppm, such as between 20 and 1500 ppm, or between 30 and 1000 ppm, or between 50 and 900 ppm, or between 100 and 900 ppm, of the crystallised PLA pellets.

The present invention provides a more energy efficient and cost-effective process for preparing crystallized PLA products, as the use of additional heat sources to effect crystallization may be avoided. Moreover, as the crystallization occurs more rapidly, the present process allows to decrease the size of crystallization equipment. Moreover, crystallized PLA pellets as prepared and obtained in accordance with the present invention are particularly advantageous in terms of stability, chemical compatibility, and food safety, allowing them to be applied in many different downstream applications. Moreover the crystallized PLA pellets of the invention can be easily handled, transported, stored and/or packaged.

Crystallized PLA pellets as prepared and obtained in accordance with the present invention may be further processed into PLA based articles. Such articles may include but are not limited to films, sheets, laminates, and packaging material. Techniques to prepare PLA-based articles are well known and include but are not limited to thermoforming, injection molding, blow molding, and extrusion. Crystallized PLA pellets, as opposed to amorphous and tacky PLA pellets or granules, can advantageously be more easily handled, transported, and fed into downstream manufacturing equipment. Moreover, by using crystallized PLA pellets as disclosed herein in downstream processing, allows to reduce problems of fouling, flow blockages, and may decrease energy demand and consumption of downstream processing equipment.

The presence of amide as defined herein in the crystallised PLA or in crystallised PLA pellets may be determined by techniques known in the art, such as but not limited to Nuclear Magnetic Resonance (NMR) spectroscopy, nitrogen content analysis, or Fourier-transform infrared spectroscopy (FTIR).

In another aspect, the present invention also relates to the use of an amide as defined herein, for increasing the crystallization speed of a PLA polymer, preferably of a PLA polymer pellet, wherein said PLA polymer has a content of D-lactide isomer of between 1.0 and 10.0% by weight of said PLA polymer, such as between 1.5 and 8.0 wt %, or between 2.0 and 6.0 wt %, or between 2.0 and 4.5 wt % of said PLA polymer, and wherein said amide is used in a melt of said PLA polymer (i.e. prior to pelletizing) to form or prepare a PLA melt comprising amide in a total amount of between 10 and 2000 ppm of said PLA polymer melt, and preferably between 20 and 1500 ppm, preferably between 30 and 1000 ppm, preferably between 50 and 900 ppm, or between 100 and 900 ppm, of the PLA polymer melt.

In certain embodiments, the invention relates to the use of a composition consisting of amide (i.e. use of amide compound) for increasing the crystallization speed of a PLA polymer pellet. More specifically, the invention relates to the use of a composition consisting of amide (i.e. use of amide compound) for increasing the crystallization speed of a PLA polymer pellet, wherein said PLA polymer has a content of D-lactide isomer of between 1.0 and 10.0% by weight of said PLA polymer, such as between 1.5 and 8.0 wt %, or between 2.0 and 6.0 wt %, or between 2.0 and 4.5 wt % of said PLA polymer, and wherein said composition (compound) is used in a melt of said PLA polymer (i.e. prior to pelletizing) to form a PLA polymer melt comprising amide in a total amount of between 10 and 2000 ppm of said PLA polymer melt, and preferably between 20 and 1500 ppm, preferably between 30 and 1000 ppm, preferably between 50 and 900 ppm, or between 100 and 900 ppm, of the PLA polymer melt.

In certain embodiments, the invention relates to the use of a (masterbatch) composition consisting of amide and a PLA polymer for increasing the crystallization speed of a PLA polymer pellet. More specifically, the invention relates to the use of a (masterbatch) composition consisting of amide and a PLA polymer for increasing the crystallization speed of a PLA polymer pellet, wherein said (masterbatch) composition is used in a melt of said PLA polymer (i.e. prior to pelletizing) to form a PLA polymer melt comprising amide in a total amount of between 10 and 2000 ppm of said PLA polymer melt, and preferably between 20 and 1500 ppm, preferably between 30 and 1000 ppm, preferably between 50 and 900 ppm, or between 100 and 900 ppm, of the PLA polymer melt. The PLA polymer used in combination with the amide may be a non-crystallised or a previously crystallised PLA, and may or may not contain amide.

In certain embodiments, the invention relates to the use of a previously crystallised PLA containing amide, as defined herein, for increasing the crystallization speed of a PLA polymer pellet. More specifically, the invention relates to the use of a previously crystallised PLA containing amide, for increasing the crystallization speed of a PLA polymer pellet wherein the previously crystallised PLA containing amide is used in a melt of said PLA polymer (i.e. prior to pelletizing) to form a PLA polymer melt comprising amide in a total amount of between 10 and 2000 ppm of said PLA polymer melt, and preferably between 20 and 1500 ppm, preferably between 30 and 1000 ppm, preferably between 50 and 900 ppm, or between 100 and 900 ppm, of the PLA polymer melt. The previously crystallized PLA preferably is used at a feed rate of from 0.5 to 15.0%, such as from 1.0 to 12.0%, or from 2.0 to 10.0%, or from 2.5 to 7.5%, with % expressed as compared to the feed rate of the PLA polymer melt.

In certain other preferred embodiments, the present invention also relates to the use of an amide as defined herein, for increasing the crystallization speed of a PLA polymer, in particular a PLA polymer pellet, wherein said amide is used in combination with a previously crystallised PLA, preferably a previously crystallised PLA as defined herein. In certain preferred embodiments, the invention relates to the use of a (blended) composition consisting of (i) amide as defined herein, and (ii) previously crystallised PLA, as defined herein, for increasing the crystallization speed of a PLA polymer pellet. The blended composition is used in a melt of said PLA polymer (i.e. prior to pelletizing) to form a PLA polymer melt comprising amide in a total amount of between 10 and 2000 ppm of said PLA polymer melt, and preferably between 20 and 1500 ppm, preferably between 30 and 1000 ppm, preferably between 50 and 900 ppm, preferably between 100 and 900 ppm, of the PLA polymer melt.

Preferably the present invention relates to a use in which both said amide and said previously crystallised PLA are used in (added to) the melt of said PLA polymer, either separately or in combination, i.e. as a blend, preferably as a molten composition. In embodiments in which the amide and the previously crystallised PLA are used separately for addition to a melt of said PLA polymer, it is preferred that the previously crystallised PLA is used at a feed rate of from 0.5 to 15.0%, such as from 1.0 to 12.0%, or from 2.0 to 10.0%, or from 2.5 to 7.5%, with % expressed as compared to the feed rate of the PLA polymer melt.

In embodiments in which the amide and the previously crystallised PLA are used in combination for addition to a melt of said PLA polymer, it is preferred that said molten composition of said amide and said previously crystallised PLA is used a feed rate (e.g. in kg/h) of from 0.5 to 15.0%, such as from 1.0 to 12.0%, or from 2.0 to 10.0%, or from 5.0 to 7.5%, with % expressed as compared to the feed rate of the PLA polymer melt.

The present invention further provides a process for increasing the crystallization speed of pellets of a PLA polymer with a content of D-lactide isomer as provided herein, comprising the step of adding amide to a melt of said PLA polymer prior to pelletizing to form a PLA melt comprising amide in a total amount of between 10 and 2000 ppm of said PLA polymer melt, such as between 20 and 1500 ppm, or between 30 and 1000 ppm, or between 50 and 900 ppm, or between 100 and 900 ppm. Such amide may be added as such or in combination with a PLA polymer as recited herein.

The present invention also provides a process for increasing the crystallization speed of pellets of a PLA polymer with a content of D-lactide isomer as provided herein, comprising the step of adding amide (e.g. in the form of a compound or masterbatch) as well as in the form of a previously crystallised PLA as defined herein, to a melt of said PLA polymer prior to pelletizing, in order to form a PLA melt comprising amide in a total amount of between 10 and 2000 ppm of said PLA polymer melt, such as between 20 and 1500 ppm, or between 30 and 1000 ppm, or between 50 and 900 ppm, or between 100 and 900 ppm. The amide and the previously crystallised PLA may be added, either separately or as a blend, preferably as a molten composition. It is further preferred that the molten composition of the amide and the previously crystallized PLA is added to the PLA melt at a feed rate of from 0.5 to 15.0%, such as from 1.0 to 12.0%, or from 2.0 to 10.0%, or from 2.5 to 7.5%, with % expressed as compared to the feed rate of the PLA polymer melt in said process.

The following examples serve to merely illustrate the invention and should not be construed as limiting its scope in any way. While the invention has been shown in only some of its forms, it should be apparent to those skilled in the art that it is not so limited, but is susceptible to various changes and modifications without departing from the scope of the invention.

### EXAMPLES

### Example 1—Degree of Crystallinity

Crystallinity degree of PLA samples (e.g. PLA pellets, pre-crystallised PLA or crystallised PLA or previously crystallised PLA) is determined via Differential Scanning Calorimetry (DSC). Differential scanning calorimetry (DSC) can be carried out using a Netzsch DSC 3500 Sirius. DSC measurements are performed from 20 to 200° C. at a heating rate of 10° C./min, and kept at 200° C. for 1 min, then cooled to 0° C. at a cooling rate of 10° C./min, kept at 0° C. for 1 min, and reheated from 0° C. to 200° C. at a heating rate of 10° C./min for the second heating run.

Degree of crystallinity (Xc) for samples is determined according to the following Equation:

$${X}_{c} = \frac{Δ {H}_{m} - Δ {H}_{c}}{ωΔ {H}_{m}^{0}} \times 100 \%$$

Wherein ΔHm and ΔHc are the enthalpies of melting and crystallization, respectively;
Wherein ω and ΔH⁰ₘ are the weight fraction of PLA, and the melting enthalpy of a 100% crystalline PLA, respectively.

The enthalpies of melting of fully crystalline polymers can be found in literature. For instance ΔH⁰ₘ=93.7 J/g for poly-L-lactide (homo-crystals); stereocomplex PLA has a different value for enthalpy of melting.

### Example 2

Example 2 illustrates that there is an increase in crystallisation rate of a PLA polymer when adding a low amount of an amide to a PLA polymer melt in accordance with the process of the invention.

To illustrate this beneficial effect, the following test protocol was applied.

### Test Protocol

Samples of amorphous PLA pellets were collected directly after pelletizing, e.g. after passing through a centrifugal dryer to remove excess water, and placed in an oven at 105° C. Samples of the PLA pellets were taken out of this oven at regular intervals and crystallinity thereof was measured using DSC as explained above. Crystallinity degree was thus measured at different time points during crystallisation, and the collected data points were fitted into a S-curve (sigmoid curve). Crystallization curves typically are S-curves: crystallization commonly starts slowly (crystals are forming), then increases rapidly (crystals are growing), then the process slows down and reaches a maximum degree of crystallinity (crystals stops growing).

The PLA polymer used in the present example consisted of a PLA polymer having about 3.4 wt % of D-lactide isomer. A PLA polymer melt was provided from said PLA polymer. N,N′-ethylenebis(stearamide) (EBS; CAS number 110-30-5) was added to the PLA polymer melt prior to pelletizing, at a concentration of 300 and 500 ppm, respectively, resulting in inventive examples IE1 and IE2. This was practically done by dosing the EBS with amorphous PLA pellets in a side-extruder equipment to prepare EBS in a molten state. The molten EBS was then fed to the PLA polymer melt of inventive examples IE1 and IE2, at a feed rate of about 2% of the feed rate of the PLA polymer melt. The same amorphous PLA was used for both examples IE1 and IE2. In the comparative example (CE1) no amide was added to the PLA polymer melt prior to pelletizing.

FIG. 1 illustrates the results of crystallinity measurements carried out at different time points for the above-identified samples (CE1, IE1, IE2). The results illustrate that addition of small amounts of EBS to a PLA polymer melt improves crystallisation and crystallisation speed. The results also illustrate faster crystallisation at higher amounts of EBS.

### Example 3

Example 3 also illustrates that there is an increase in crystallisation rate of a PLA polymer when adding a low amount of an amide to a PLA polymer melt in accordance with the process of the invention. In the present example, the amide was fed to PLA polymer melt in combination (admixture) with a previously crystallised PLA. The same test protocol as explained for example 2 was applied to evaluate crystallisation and crystallisation speed.

The PLA polymer used in the present example consisted of a PLA polymer having about 3.4 wt % of D-lactide isomer. A PLA polymer melt was provided from said PLA polymer. N,N′-ethylenebis(stearamide) (EBS; CAS number 110-30-5) was added to the PLA polymer melt prior to pelletizing, at a concentration of 300, 500, 700, or 900 ppm, respectively, resulting in inventive examples IE3 to IE6. This was practically done by blending (dosing) the EBS with previously crystallised PLA pellets into a side-extruder equipment to prepare a composition comprising EBS in a molten state. The molten EBS was then fed to the PLA polymer melt of examples IE3 to IE6, at a feed rate of the PLA polymer melt of about 2% for IE3 and of about 5% for IE4 to IE6 (feed rate expressed in % as compared to the feed rate of the PLA polymer melt fed into the process). For comparison, a comparative example (CE2) was prepared by adding previously crystalised PLA to the PLA polymer melt prior to pelletizing. No amide was added in comparative example CE2. The previously crystallised PLA consisted of a PLA polymer having about 3.4 wt % of D-lactide isomer (the same PLA polymer as applied to form the PLA melt), and a crystallinity degree of about 40%. The same previously crystallised PLA was used in all examples CE2 and IE3 to IE6. An overview of the examples of this experiment is given in Table 1. FIG. 2 illustrates results of crystallinity measurement carried out at different time points for the different examples.

TABLE 1

| | | previously |
|---|---|---|
| | EBS | crystallised |
| example | (ppm) | PLA feed rate (%) |
| CE2 | no | 5 |
| IE3 | 300 | 2 |
| IE4 | 500 | 5 |
| IE5 | 700 | 5 |
| IE6 | 900 | 5 |

Results of this experiment indicate that the addition to the PLA polymer of a low amount of an amide, here blended with a previously crystalised PLA, significantly improved crystallisation and the speed of crystallisation. The results also illustrate faster crystallisation at higher amounts of EBS.

### Example 4

Example 4 illustrates beneficial effects on crystallisation and crystallisation speed of a PLA polymer when feeding an amide in combination with previously crystallised PLA to a PLA polymer melt thereof according to a process of the invention. The same test protocol as explained in example 2 was applied.

PLA pellets were prepared by providing a PLA polymer melt and by adding N,N′-ethylenebis (stearamide) (EBS; CAS number 110-30-5) to said melt. In all examples IE7, IE8 and IE9, EBS was added at a concentration of 500 ppm. In examples IE8 and IE9, EBS was administered to the PLA polymer melt in combination with previously crystallized PLA. This was practically done by blending the EBS with previously crystallised PLA pellets into a side-extruder equipment to prepare a molten composition comprising EBS and the previously crystallised PLA in a molten state. The molten composition was then fed to the PLA polymer melt at a feed rate of 5% (IE8) or 10% (IE9) (feed rate expressed in % as compared to the feed rate of the PLA polymer melt fed into the process). In example IE7, EBS was supplied to the PLA melt in the absence of previously crystallised PLA.

The PLA polymer used in all samples of the present example consisted of a PLA polymer having about 3.4 wt % of D-lactide isomer according to the invention. The previously crystallised PLA also consisted of a PLA polymer having about 3.4 wt % of D-lactide isomer (the same PLA polymer as applied to form the PLA melt), and a crystallinity degree of about 40%. The same previously crystallised PLA was used in IE8 and IE9.

FIG. 3 illustrates the results of crystallinity measurement carried out at different time points for the different examples. Results of this experiment indicate a clear beneficial effect on crystallization and crystallisation speed by adding low amounts of an amide in combination (blended) with a previously crystallised PLA. The crystallisation speed improves with increasing amounts of previously crystallised PLA.

### Example 5

Example 5 is another example that illustrates that there is an increase in crystallisation rate of a PLA polymer pellet when adding a low amount of amide to a PLA polymer melt in order to form a PLA melt having low amide content in accordance with the process of the invention. This example further shows the beneficial effects on crystallisation rate (synergetic improvement) when treating the PLA polymer melt with a combination of an amide compound (e.g. EBS), and a previously crystallised PLA containing amide.

To illustrate this beneficial effect, the same test protocol was applied as in examples 2 to 4.

In all herein presented examples, samples of non-crystallised PLA pellets were collected (at timepoint T0) directly after pelletizing, e.g. after passing through a centrifugal dryer to remove excess water. At this timepoint (T0), the samples were placed in a thermos bottle to prevent the samples to cool down. Time was recorded and the samples were brought immediately to a lab. At T* the samples were removed from the thermos bottle and placed in an oven at 105° C. At the different time intervals (from T0), a pellet was taken and crystallinity was measured by DSC methodology as explained above (example 1).

It is observed that by using this protocol the PLA pellets were prevented for cooling down after pelletization. The experimental protocol adopted in the above example section therefore reproduces latent heat crystallisation conditions.

The PLA polymer used in present example 5 consisted of a PLA polymer having about 3.4 wt % of D-lactide isomer. PLA pellets were prepared by subjecting a melt of the PLA polymer to pelletization. Prior to pelletization, the PLA polymer melt was treated (injected) with N,N′-ethylenebis(stearamide) (EBS; CAS number 110-30-5) in examples IE10 and IE11, and with a previously crystallised PLA in example IE11. In a comparative example (CE3), no amide and no previously crystallised PLA was added to the PLA polymer melt. The previously crystallised PLA consisted of a PLA polymer having about 3.4 wt % of D-lactide isomer (the same PLA polymer as applied to form the PLA melt), with a crystallinity degree of about 40%, and an EBS content of about 500 ppm.

Example IE10 was prepared by dosing the EBS with non-crystallised PLA pellets in a side-extruder equipment to prepare EBS in a molten state. Non-crystallised PLA pellets were fed to the side-extruder at a feed rate of about 5% of the feed rate of the main PLA polymer melt. The mixture of non-crystallised PLA and EBS was then fed and mixed in a static mixer with the PLA polymer melt before pelletizing.

Example IE11 was prepared by blending (dosing) the EBS with previously crystallised PLA pellets into a side-extruder equipment to prepare a composition comprising EBS in a molten state. The previously crystallized PLA was fed into the side-extruder at a rate compared to the main PLA polymer melt of about 5% (feed rate expressed in % as compared to the feed rate of the main PLA polymer melt). The mixture of previously crystallized PLA and molten EBS was then fed and mixed in a static mixer with the PLA polymer melt before pelletizing.

An overview of the examples of this experiment is given in Table 2, also reporting the total amide concentration in the resulting PLA melt before pelletization thereof. FIG. 6 illustrates results of crystallinity measurement carried out at different time points for the different examples.

TABLE 2

| | | previously | EBS |
|---|---|---|---|
| | EBS | crystallised | concentration |
| example | injection | PLA feed rate (%) | (ppm) |
| CE3 | No | 0 | 0 |
| IE10 | Yes | 0 | 500 |
| IE11 | Yes | 5 | 500 |

1. A process for the preparation of crystallized polylactide (PLA) pellets, said process comprising the steps of:
a) providing a PLA polymer melt, wherein the PLA polymer has a content of D-lactide isomer of between 1.0 and 10.0 wt % of said PLA polymer;
b) pelletizing the PLA polymer melt into PLA pellets, and
c) crystallizing the PLA pellets, thereby obtaining crystallized PLA pellets,
wherein said process is characterised in that amide is added to said PLA polymer melt before step b) to form a PLA polymer melt comprising amide in a total amount of between 10 and 2000 ppm of the PLA polymer melt.

2. The process according to claim 1, wherein the PLA pellets are crystallised by means of latent heat crystallisation.

3. The process according to claim 1, wherein during pelletizing the average PLA pellet temperature remains above the glass transition temperature (Tg) of the PLA polymer.

4. The process according to claim 1, wherein crystallizing is carried out at temperatures of between 9° and 130° C.

5. The process according to claim 1, wherein amide is added to form a PLA polymer melt comprising amide in a total amount of between 20 and 1500 ppm of the PLA polymer melt.

6. The process according claim 1, wherein said amide comprises at least one compound of formula (I) and/or at least one compound of formula (II), 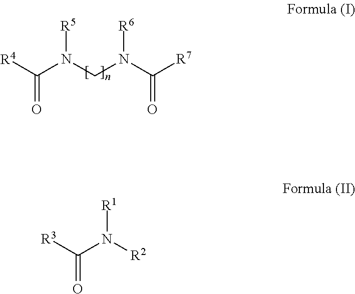
wherein each of R¹, R², R⁵, and R⁶ is independently hydrogen or is selected from the group comprising alkyl and alkenyl, wherein each group can be unsubstituted or substituted with one or more hydroxyl groups, and
wherein each of R³, R⁴ and R⁷ is independently selected from the group comprising alkyl and alkenyl, wherein each group can be unsubstituted or substituted with one or more hydroxyl groups, and
wherein n is an integer selected from 1, 2, 3, 4, 5, 6, or 7.

7. The process according to claim 1, wherein said amide is selected from the group consisting of a saturated fatty acid bisamide, an unsaturated fatty acid bisamide, a saturated fatty acid monoamide, an unsaturated fatty acid monoamide, an N-alkyl substituted fatty acid monoamide, and any mixtures thereof.

8. The process according to claim 1, wherein said amide is a saturated fatty acid bisamide of formula (I), wherein R⁵ and R⁶ are hydrogen, wherein each of R⁴ and R⁷ is independently a C₄₋₂₈alkyl, which can be unsubstituted or substituted with one or more hydroxyl groups, and wherein n is an integer selected from 1, 2, 3, 4, 5, 6, or 7.

9. The process according to claim 1, wherein said amide is selected from the group consisting of ethylenebis stearamide, ethylenebis caprylic acid amide, ethylenebis capramide, ethylenebis lauramide, ethylenebis myristamide, ethylenebis palmitamide, ethylenebis isostearamide, ethylenebis behenamide, ethylenebis (12-hydroxystearamide), methylenebis caprylic acid amide, methylenebis capramide, methylenebis lauramide, methylenebis myristamide, methylenebis palmitamide, methylenebis stearamide, methylenebis isostearamide, methylenebis behenamide, methylenebis (12-hydroxystearamide), butylenebis stearamide, butylenebis behenamide, hexamethylenebis stearamide, butylenebis (12-hydroxystearamide), hexamethylenebis behenamide, hexamethylenebis (12-hydroxystearamide), and N,N′-distearyl adipamide.

10. The process according to claim 1, wherein the PLA polymer has a content of D-lactide isomer of between 1.5 and 8.0 wt % of said PLA polymer.

11. The process according to claim 1, wherein amide is added to the PLA polymer melt before step b) in the form of a composition consisting of amide.

12. The process according to claim 1, wherein said amide is added to said PLA polymer melt before step b) in the form of a composition obtained by melt-blending amide with a PLA polymer.

13. The process according to claim 1, comprising the step of adding to the PLA polymer melt before step b)
i) amide, and
ii) a previously crystallised PLA;
wherein said previously crystallised PLA is characterised in that it:
has a degree of crystallinity, prior to addition to the process, of at least 20.0%;
has a content of D-lactide isomer equal to or lower than 10.0 wt % based on said previously crystallised PLA, and
optionally contains amide in a total amount of at most 2000 ppm, with ppm based on the previously crystallised PLA.

14. The process according to claim 13, wherein said previously crystallised PLA is added at a feed rate of from 0.5 to 15.0%, with % expressed as compared to the feed rate of the PLA polymer melt as provided in step a).

15. The process according to claim 13, wherein said amide and said previously crystallised PLA are added separately to said PLA polymer melt before step b).

16. The process according to claim 13, wherein said amide and said previously crystallised PLA are melt blended, to form a molten composition, and wherein said molten composition is added to said PLA polymer melt before step b).

17. The process according to claim 13, wherein said previously crystallised PLA has a crystallinity degree of at least 25.0%.

18. The process according to claim 13, wherein said previously crystallised PLA contains amide in a total amount of between 10 and 2000 ppm based on the previously crystallised PLA.

19. The process according to claim 13, wherein the previously crystallised PLA has a content of D-lactide isomer of between 0.1 and 9.0 wt %.

20. The process according to claim 13, wherein the previously crystallised PLA is a crystallised form of the PLA polymer melt provided in step a).

21. The process according to claim 1, wherein the PLA pellets obtained in step b) are crystallized in step c) by the steps of:
c1) keeping the PLA pellets in motion for a suitable period of time at a temperature of between 9° and 130° C., thereby obtaining pre-crystallised PLA, whereby said pre-crystallised PLA preferably has a degree of crystallinity of at least 3.0%; and
c2) transporting the pre-crystallised PLA to a crystallization vessel, and maintaining said pre-crystallised PLA in said crystallization vessel for a suitable period of time at a temperature of between 9° and 130° C., thereby obtaining crystallised PLA, whereby said crystallised PLA preferably has a degree of crystallinity at least 20.0%.

22. Crystallised PLA pellets, obtainable or obtained by carrying out a process according to claim 1, wherein said pellets have
a D-lactide isomer content of between 1.0 and 10.0 wt % based on the crystallised PLA; and
a degree of crystallinity of at least 20.0%, and
a total amount of amide of between 10 and 2000 ppm of the crystallised PLA pellets.

23. The process according to claim 1, wherein the PLA polymer melt comprises amide in a total amount of between 20 and 1500 ppm of the PLA polymer melt and wherein addition of the amide to the PLA polymer melt increases crystallization speed of pellets of the PLA polymer.

24. The process according to claim 23, wherein said amide is used in combination with a previously crystallised PLA, wherein said amide and said previously crystallised PLA are added in a melt of said PLA polymer prior to pelletizing, either separately or as a blend.

25. A process for increasing the crystallization speed of pellets of a polylactide (PLA) polymer, wherein said PLA polymer has a content of D-lactide isomer between 1.0 and 10.0% by weight of said PLA polymer, comprising the step of forming a melt of said PLA polymer and an amide prior to pelletizing the PLA polymer, wherein said melt comprises said amide in a total amount between 10 and 2000 ppm of the PLA polymer melt.

26. The process according to claim 25, wherein said amide is added in combination with a previously crystallised PLA in a melt of said PLA polymer prior to pelletizing, either separately or as a blend.
